(19) United States
(12) Patent Application Publication
(10) Pub. No.: US 2004/0209058 A1
(43) Pub. Date: Oct. 21, 2004

(54) Paper products including surface treated thermally bondable fibers and methods of making the same

(76) Inventors: Hung Liang Chou, Neenah, WI (US); H. Charles Thomas, Green Bay, WI (US); Daniel W. Sumnicht, Green Bay, WI (US)

Correspondence Address: Finnegan, Henderson, Farabow,, Garrett & Dunner, L.L.P., 1300 I Street, N.W., Washington, DC, 20005-3315, US

(21) Appl. No.: 10/676,017

(22) Filed: Oct. 2, 2003

Related U.S. Application Data
(60) Provisional application No. 60/415,406, filed on Oct. 2, 2002.

(51) Int. Cl. B32B 3/00

(52) U.S. Cl. 428/292.1; 428/156

(57) ABSTRACT

The present invention is a paper product including a thermally bondable fiber which may be surfactant coated. The paper product according to the present invention has improved strength and absorbency characteristics. The paper product of the present invention may be embossed and heat cured to result in an attractive and absorbent product.

### DESCRIPTION OF THE INVENTION

This application claims the benefit of U.S. provisional application No. 60/415,406 filed Oct. 2, 2002, which is incorporated herein by reference.

The present invention is directed to a paper product containing thermally bondable fibers that can provide improved product attributes. Still further, the present invention is directed to a method of making the paper product described above. In yet another embodiment, the present invention is directed to a method of making an improved embossed product according to the present invention.

One embodiment of the present invention provides a wet-formed paper product comprising papermaking fiber and at least one thermally bondable fiber.

Another embodiment of the present invention provides a paper product comprising papermaking fiber and at least one thermally bondable fiber, wherein the paper product exhibits a CD Wet Breaking length of at least about 250 meters.

In still another embodiment, the present invention provides a paper product comprising papermaking fiber and at least one thermally bondable fiber wherein the paper product exhibits a CD Wet Breaking length of at least about 250 meters and a SAT of at least about 5 g/g.

One embodiment of the present invention provides a paper product comprising papermaking fiber and at least one thermally bondable fiber, wherein the paper product exhibits a reticulated matrix of thermally bondable fibers.

Still another embodiment of the present invention provides a method of making a paper product comprising dispersing papermaking fibers in an aqueous solution, dispersing at least one thermally bondable fiber in an aqueous solution, forming said papermaking fibers and said thermally bondable fiber into a nascent web, and drying said web.

Additional aspects of the invention will be set forth in part in the description which follows, and in part will be apparent from the description, or may be learned by practice of the invention.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention, and, together with the description, serve to explain the principles of the invention.

### BRIEF DESCRIPTION OF THE DRAWINGS

FIG. 1 illustrates a conventional wet press process.

FIG. 2 illustrates one conventional through-air-drying process.

FIG. 3 illustrates one embodiment of a stock flow diagram for making one stratified product embodiment according to the present invention.

FIG. 4 plots time versus intensity of mixing for varied feed locations for thermally bondable fibers.

FIG. 5 illustrates the effect of varied processing of thermally bondable bicomponent fiber on sheet formation.

FIG. 6 illustrates the effect of basis weight and the amount of thermally bondable bicomponent fiber on sheet formation.

FIGS. 7A and 7B illustrates the reticulated matrix of thermally bondable bicomponent fiber in a 15 pound stratified sheet containing 15% bicomponent surface modified thermally bondable fiber.

FIG. 8 illustrates the bonding of both wood fiber and thermally bondable fiber in product according to the present invention.

FIG. 9 illustrates the bonding of both wood fiber and thermally bondable fiber in the Yankee side of a stratified product according to the present invention.

FIG. 10 illustrates the bonding of both wood fiber and thermally bondable fiber in the air-side of a stratified product according to the present invention.

FIGS. 11A and 11B illustrate a two-ply towel made from 15 pound stratified sheets containing 15% bicomponent thermally bondable fiber.

FIG. 12 plots SAT capacity as a function of CD Wet Breaking length for a product according to the prior art versus traditionally produced products.

FIG. 13 illustrates the relationship between SAT and GM dry tensile strength for TAD handsheets made and dried on a 100-mesh screen.

FIG. 14 illustrates the relationship between SAT and GM dry tensile strength for TAD handsheets dried and shaped using a Voith 44G TAD fabric.

FIG. 15 illustrates the relationship between SAT and GM wet tensile strength for TAD handsheets dried on a 100-mesh screen.

FIG. 16 illustrates the relationship between SAT and GM wet tensile strength for TAD handsheets dried on a Voith 44G TAD fabric.

FIG. 17 illustrates the relationship between Caliper and GM wet tensile strength for TAD handsheets dried on a 100-mesh screen.

FIG. 18 illustrates the relationship between Caliper and GM wet tensile strength for TAD handsheets dried and shaped on the Voith 44G TAD fabric.

FIG. 19 illustrates the relationship between GM wet tensile strength and GM dry tensile strength for TAD handsheets dried on a 100-mesh wire.

FIG. 20 illustrates the relationship between GM wet tensile strength and GM dry tensile strength for TAD handsheets dried and shaped using a Voith 44G TAD fabric.

FIG. 21 illustrates the relationship between the amount of bicomponent thermally bondable fiber and the SAT for a stratified 30 lbs/ream two-ply embossed towel.

FIG. 22 illustrates the relationship between the amount of bicomponent thermally bondable fiber and the SAT for a homogeneous 30 lbs/ream two-ply embossed towel.

FIG. 23 illustrates the relationship between the amount of bicomponent thermally bondable fiber and the CD wet Tensile for a stratified 30 lbs/ream two-ply embossed towel.

FIG. 24 illustrates the relationship between the amount of bicomponent thermally bondable fiber and the CD wet Tensile for a homogeneous 30 lbs/ream two-ply embossed towel.

FIG. 25 illustrates the relationship between the amount of bicomponent thermally bondable fiber and the Wet Bulk for a stratified 30 lbs/ream two-ply embossed towel.

FIG. 26 illustrates the relationship between the amount of bicomponent thermally bondable fiber and the Wet Bulk for a homogeneous 30 lbs/ream two-ply embossed towel.

FIG. 27 illustrates the GM Tensile of a cured and embossed 28 lbs/ream one-ply towel as a function of the amount of bicomponent thermally bondable fiber and the order of curing and embossing.

FIG. 28 illustrates the Caliper of a cured and embossed 28 lbs/ream one-ply towel as a function of the amount of bicomponent thermally bondable fiber and the order of curing and embossing.

FIG. 29 illustrates resiliency of a cured and embossed 28 lbs/ream one-ply towel as a function of the amount of bicomponent thermally bondable fiber and the order of curing and embossing.

FIG. 30 illustrates the Wet Tensile of a cured and embossed 28 lbs/3000 ft² one-ply towel as a function of the amount of bicomponent thermally bondable fiber and the order of curing and embossing.

FIG. 31 illustrates ratio of Wet/Dry Tensile as a function of the amount of bicomponent thermally bondable fiber and the order of curing and embossing.

FIG. 32 illustrates the effect of Yankee temperature on CD Wet Tensile for two different bicomponent fibers including polylactic acid.

FIG. 33 illustrates the effect of the inclusion of a thermally bondable fiber on absorbency and CD wet tensile.

FIG. 34 illustrates the effect of thermal bonding on SAT for various two-ply sheets including thermally bondable fibers.

FIG. 35 illustrates the effect on modulus of bonding a thermally bondable fiber included within the sheet.

FIG. 36 illustrates the effect on MD stretch of bonding a thermally bondable fiber included within the sheet.

FIG. 37 illustrates the effect on CD stretch of bonding a thermally bondable fiber included within the sheet.

FIG. 38 illustrates the melt profile of one polylactic acid used as a thermally bondable material in the formation of a thermally bondable fiber.

FIG. 39 illustrates the melt profile of a polylactic acid for use in the present invention.

### DETAILED DESCRIPTION OF THE INVENTION

Reference will now be made in detail to the embodiments of the invention, examples of which are illustrated in the accompanying drawings. Wherever possible, the same reference numbers will be used throughout the drawings to refer to the same or like parts.

According to the present invention, an absorbent paper web can be made by dispersing fibers into an aqueous slurry and depositing the aqueous slurry onto the forming wire of a papermaking machine. Any art recognized forming scheme might be used. For example, an extensive but non-exhaustive, list includes a crescent former, a C-wrap twin-wire former, an S-wrap twin-wire former, a suction breast roll former, a fourdrinier former, or any other art recognized forming configuration.

The forming fabric can be any art recognized foraminous member including single layer fabrics, double layer fabrics, triple layer fabrics, photopolymer fabrics, and the like. Appropriate forming fabrics will be readily apparent to the skilled artisan. A non-exhaustive list of forming fabrics for use in the present invention include U.S. Pat. Nos. 4,157,276; 4,605,585; 4,161,195; 3,545,705; 3,549,742; 3,858,623; 4,041,989; 4,071,050; 4,112,982; 4,149,571; 4,182,381; 4,184,519; 4,314,589; 4,359,069; 4,376,455; 4,379,735; 4,453,573; 4,564,052; 4,592,395; 4,611,639; 4,640,741; 4,709,732; 4,759,391; 4,759,976; 4,942,077; 4,967,085; 4,998,568; 5,016,678; 5,054,525; 5,066,532; 5,098,519; 5,103,874; 5,114,777; 5,167,261; 5,199,467; 5,211,815; 5,219,004; 5,245,025; 5,277,761; 5,328,565; and 5,379,808, all of which are incorporated herein by reference.

The web can be homogeneously formed or stratified. When homogeneously forming a web, the stock in the various headbox chambers is substantially uniform. As the stock is deposited from the various chambers onto the forming wire, the nascent web that is formed has a composition which is substantially uniform throughout its cross-section, i.e., homogeneous. When forming a web by stratification, the stock in the various headbox chambers is of differing compositions. As the stock is deposited from the various chambers onto the forming wire, the varied compositions form separate layers within the cross-section of the nascent web. Stratification makes it possible to manipulate the properties associated with different areas of the sheet. For example, the web may be produced by placing harsher, stronger fibers in the interior of the web with softer fibers on the outside. Any art recognized stratification technique can be used in the present invention. Stratification techniques will be readily apparent to the skilled artisan.

The fibers used to form the web of the present invention include thermally bondable fibers. As used in the present invention, thermally bondable fibers have fiber integrity, often in the form of a matrix forming portion, and bondability in the form of a bondable portion to allow thermal bonding of the web structure. While the subsequent discussion may be directed primarily to multi-component fibers having a matrix forming portion and a bondable portion, when the fibers are monocomponent fibers they will be bondable materials capable of maintaining fiber integrity (which generally corresponds to the attributes discussed regarding the matrix forming portion of multicomponent fibers). The thermally bondable fibers according to the present invention either have a bondable portion which is hydrophilic or have been surface modified to impart hydrophilicity thereby allowing the fibers to be dispersed. According to one embodiment of the present invention, surface modification allows the thermally bondable fibers to be dispersed substantially uniformly throughout the paper product. According to one embodiment, the thermally bondable fibers have a bondable portion that is made of polylactic acid, also referred to as “PLA.” According to another embodiment of the invention, these PLA containing thermally bondable fibers are fibers that can be thermally bonded on a Yankee dryer. According to another embodiment of the present invention, PLA fibers achieve high adhesion to a Yankee dryer resulting in improved creping effectiveness. According to yet another embodiment of the present invention, the thermally bondable fibers have a sufficiently slow melt profile that they will not flow on the surface of the Yankee dryer. Fibers for use in the present invention may have any art recognized cross section. According to yet another embodiment of the present invention, the fibers have a compressible hollow cross section that allows the nascent web to be effectively dewatered during pressing, but rebounds after the press nip to improve internal sheet structure.

The fibers can be produced in any art-recognized arrangement of the bondable portion and the matrix-forming portion. Appropriate configurations include, but are not limited to, a core/sheath arrangement and a side-by-side arrangement. While the invention may be described with respect to embodiments in which a core and sheath arrangement have been used, it should be understood that a side by side or other appropriate arrangement is also contemplated for use in the present invention.

Thermally bondable fibers for use according to the present invention can be formed from any thermoplastic material. Thermoplastic materials that may be used to form the thermally bondable fibers for use in the present invention can be chosen from one or more of the following: polyesters, polyolefins, copolyolefins, polyethylenes, polypropylenes, polybutylenes, polyethylene terephthalates, poly trimethylene terephthalates, polybutylene terephthalates, polyurethanes, polyamides, polycarboxylic acids, alkylene oxides, polylactic acid and mixtures thereof. The foregoing list is merely representative and other art recognized materials will be readily apparent to the skilled artisan. Fibers for use in the present invention exhibit a “hydrophilicity.” Hydrophilicity refers to the fibers ability to disperse reasonably uniformly with cellulosic fibers during a wet forming process. Recognizing that fiber configurations can exist making contact angle difficult to measure, hydrophilicity generally refers to a fiber having a contact angle of less than 90° with the generally aqueous fluid used in the furnish.

The thermally bondable fibers can be selected from monocomponent, bicomponent fibers, tricomponent fibers, or other multi-component fibers. The use of monocomponent fibers is limited to fibers having appropriate characteristics including dispersion and melt profiles. Monocomponent fibers for use in the present invention are dispersible in the sheet matrix during a wet forming process. Further, monocomponent fibers for use in the present invention have a melt profile that results in softening and bonding of the fibers without loss of fiber integrity and thereby loss of strength or destruction of the fiber matrix.

Bicomponent and tricomponent fibers for use according to the present invention include any art recognized bicomponent or tricomponent fibers. Thermally bondable fibers for use in the present invention may have at least one matrix forming material that does not melt at temperatures to which the product will be subjected. This material provides strength and stability allowing for differing melt profiles in the thermally bondable portion. According to an embodiment of the present invention, the matrix forming material does not melt at a temperature of less than about 360° F. According to another embodiment of the present invention, the fibers have at least one matrix forming material that melts at temperatures of not less than about 400° F. another embodiment, the thermally bondable fibers for use in the present invention have at least one matrix forming material that does not melt at a temperature of less than about 450° F. The matrix forming material can be selected based not only on its melt temperature and strength characteristics, but may also be selected based upon its shrinking characteristics when exposed to heat. For example, according to one embodiment of the invention, when Celbond 105 fibers were used, the fibers tended to curl when exposed to heat. Likewise, according to another embodiment of the invention, fibers formed of polypropylene and polylactic acid also tended to curl when exposed to heat. According to another embodiment of the invention, when a polyester and polylactic acid fiber was exposed to heat, it contracted linearly and did not tend to curl. Selection of an appropriate material for formation of the fibers based upon the desired end product would be readily apparent to the skilled artisan.

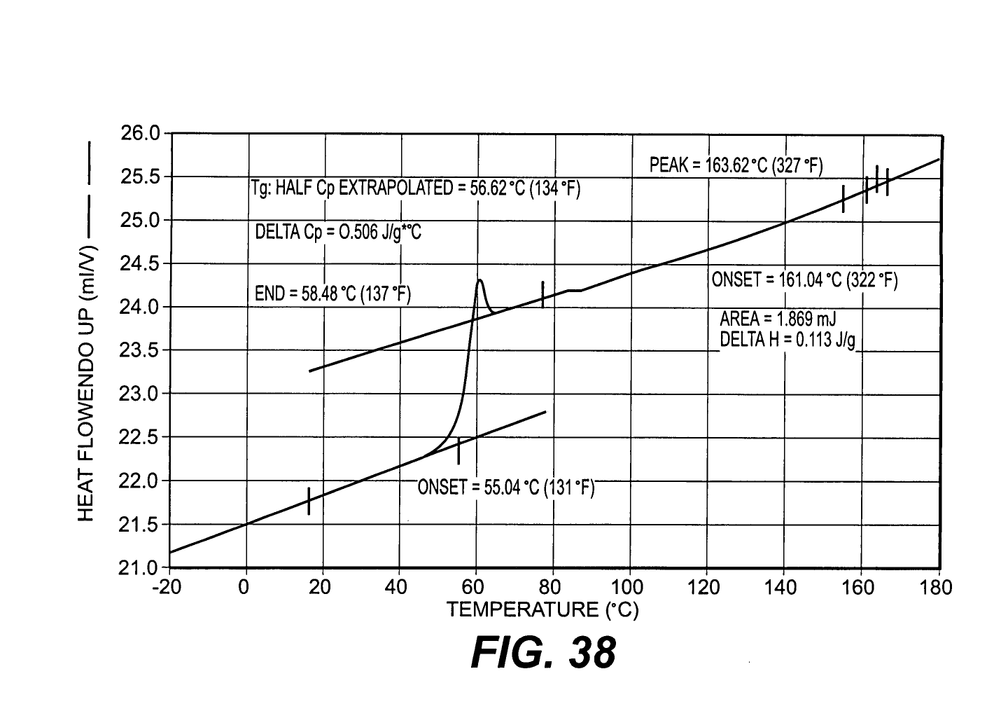

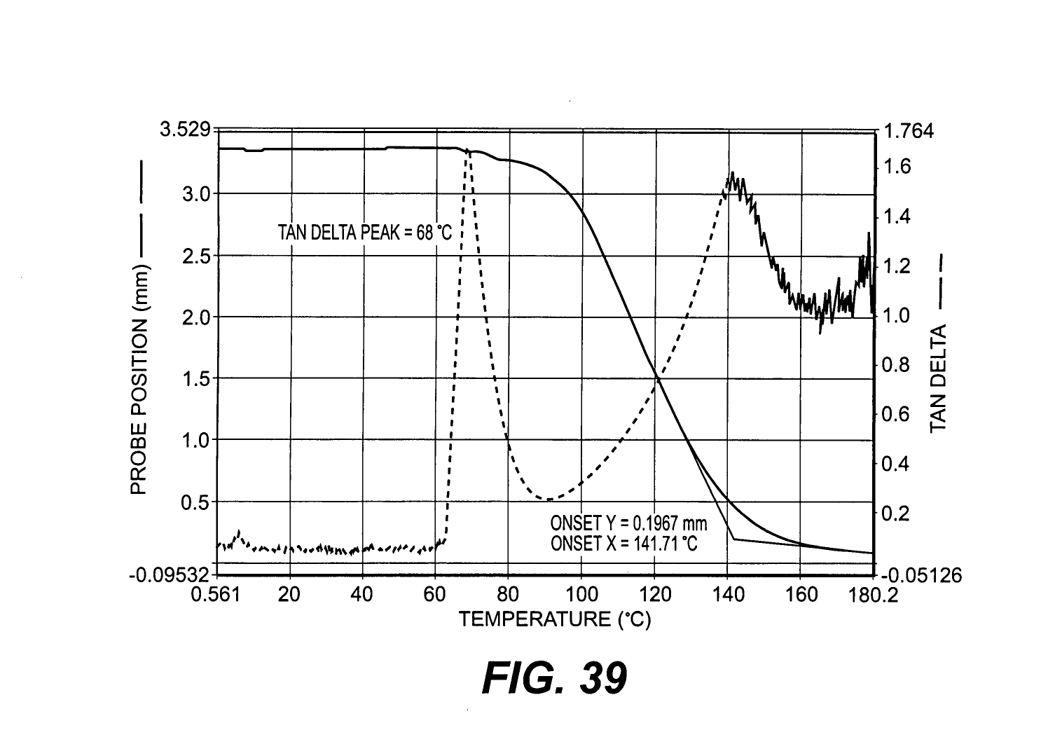

The bondable material which is used in conjunction with the matrix forming material may melt at temperatures of from between about 165° F. and about 360° F. According to another embodiment, the bondable portion melts at temperatures of from between about 200° F. and about 310° F. In still another embodiment, the bondable portion melts at temperatures of from between about 260° F. and about 275° F. The bondable materials for use according to the present invention may exhibit a glass transition temperature or a softening profile rather than a major melting point. For example, the melt profile of one polylactic acid thermally bondable resin for use according to the present invention can be seen in FIG. 38. As seen in FIG. 38, the polylactic acid sample exhibited a glass transition in the range of 55° C. to 58° C. Below the glass transition temperature, the material was “glass-like” or brittle. Above the glass transition temperature, the material was “rubber like.” PLA fibers for use in the present invention may be chosen based upon their melt profiles. PLA may be manipulated during manufacture to adjust melt characteristics. FIG. 39 is another illustration of a polylactic acid for use in the present invention.

According to one embodiment of the present invention, thermally bondable fibers having different melt profiles can be used in a single product. The differing thermally bondable fibers may be generally homogenously dispersed within the sheet or may be included within differing layers of a stratified sheet.

The thermally bondable fibers for use with the present invention include any monocomponent fibers which have the described melt profile or any multi-component fibers which have the aforementioned bondable portion and matrix forming portion. According to one embodiment of the present invention, the thermally bondable fibers are bicomponent or tricomponent fibers.

According to one embodiment of the present invention, bicomponent fibers can include a core material surrounded by sheath materials. Appropriate bicomponent fibers will be readily apparent to the skilled artisan.

According to one embodiment of the present invention, tricomponent fibers can include one or more core materials surrounded by one or more sheath materials. Appropriate tricomponent fibers will be readily apparent to the skilled artisan.

According to one embodiment of the present invention, appropriate fibers may be selected from bicomponent and tricomponent fibers in which the bondable portion is polylactic acid. According to yet another embodiment of the invention, the matrix forming material is chosen from one or more of polypropylene, polyester, and polyethylene teraphthalate.

According to another embodiment of the present invention, fibers appropriate for use in the present invention may be chosen from at least one of the copolyolefin fibers produced by KOSA, Houston, Tex., under the tradename CELBOND. Fibers for use in the present invention include fibers having a polyethylene terephthalate core and a copolyolefin sheath and can be obtained from KOSA under the tradename CELBOND 105.

Thermally bondable fibers for use in the present invention can have any fiber length available. According to one embodiment of the present invention, the thermally bondable fibers for use in the present invention have a fiber length of less than about 25 mm. According to another embodiment, the thermally bondable fibers have a length of less than about 13 mm. In yet another embodiment, the thermally bondable fibers for use in the present invention have a fiber length of greater than about 1 mm. According to still another embodiment of the present invention, the thermally bondable fibers have a length of at least about 6 mm. Finally, according to yet another embodiment of the present invention, the thermally bondable fibers have a length of from about 1 mm to about 13 mm.

Fibers having different fiber diameters and deniers can be used in the present invention. Selection of appropriate fiber weights for fibers having different diameters and deniers will be readily apparent to the skilled artisan. For example, synthetic furnishes, with 15 weight percent synthetic fiber, were considered. Table 1 shows that the different deniers used result in varying lengths of synthetic fiber per 100 grams of furnish. The 3.4 denier fiber has a larger diameter than the 2.9 denier fiber, but 15% less length. Directionally, the larger diameter may help bulk and void volume, but the lower length of synthetic fiber will decrease the number of fiber crossings and bonding.

TABLE 1

| | Length provided by | Weight % required |
|---|---|---|
| Effect of denier on | 15 wt. % in furnish, | to equal 450 m/100 g |
| furnish length. | m/100 g furnish | furnish |
| Celbond 105, | 450 | 15 |
| 3 denier | | |
| PLA/PET, | 466 | 14.5 |
| 2.9 denier | | |
| PLA/PP, 3.4 denier | 397 | 17 |
| PLA/PP, 4.1 denier | 329 | 20.5 |

According to one embodiment of the present invention, when a bondable material is used that is not inherently hydrophilic or dispersible, the fibers may be surface modified to render them hydrophilic. The fibers may be treated by any art recognized method which will render the surface sufficiently hydrophilic to allow dispersion of the fibers in a wet forming process. According to one embodiment, the fibers are treated with one or more surface active agents. Surface active agents can include one or more surfactants. According to one embodiment of the present invention, the surfactant is chosen from at least one of an anionic surfactant, a nonionic surfactant, a cationic surfactant, and a zwitterionic surfactant. Exemplary surface finishes include polyethylene glycol esters. According to another embodiment of the present invention, the fibers may be produced by compounding the bondable portion with other polymeric materials having hydrophilic portions that can render the surface of the bondable portion hydrophilic.

One method for determining whether thermally bondable fibers include applied surface active agents may include agitating the fibers in hot water to cause the surface active agent to leach, thereby allowing one to ascertain the type and amount of surface active agent. Alternatively, the fiber or a sheet sample containing the fiber can be subjected to a methanol extraction, either at room temperature or at an elevated temperature, again causing the surfactant to leach, thereby allowing one to ascertain the type and amount of the surface active agent.

According to one embodiment, thermally bondable fibers for use according to the present invention may include at least about 0.1% to about 5% surface active agent. According to another embodiment, thermally bondable fibers for use according to the present invention may include at least about 0.5% surface active agent.

Surface modification of the fibers can include any method capable of rendering the surface of the fiber hydrophilic and is not limited to the addition of a surface agent, but may instead include a treatment of the surface. Surface treatments may include, for example, corona or other plasma discharge or chemical etching.

The papermaking fibers used to form the web of the present invention may also include cellulosic fibers, commonly referred to as wood pulp fibers, liberated in a chemical or mechanical pulping process from softwood (gymnosperms or coniferous trees) and hardwoods (angiosperms or deciduous trees). The particular tree and pulping process used to liberate the tracheid are not critical to the success of the present invention.

Papermaking fibers from diverse material origins may be used to form the web of the present invention, including non-woody fibers liberated from sabai grass, rice straw, banana leaves, paper mulberry (i.e., bast fiber), abaca leaves, pineapple leaves, esparto grass leaves, kenaf fibers, and fibers from the genus hesperalae in the family agavaceae. Also recycled fibers and refined fibers, which may contain any of the above fiber sources in different percentages, can be used in the present invention. Other natural and synthetic fibers such as cotton fibers, wool fibers, and polymer fibers can be used in the present invention. The particular fiber used is not critical to the success of the present invention.

Papermaking fibers can be liberated from their source material by any one of a number of chemical pulping processes familiar to the skilled artisan, including sulfate, sulfite, polysulfite, soda pulping, etc. Furthermore, papermaking fibers can be liberated from source material by any one of a number of mechanical/chemical pulping processes familiar to anyone experienced in the art, including mechanical pulping, thermo-mechanical pulping, and chemi-thermo-mechanical pulping. The pulp can be bleached, if desired, by chemical means, including the use of chlorine, chlorine dioxide, oxygen, etc. These pulps can also be bleached by a number of familiar bleaching schemes, including alkaline peroxide and ozone bleaching.

The present invention can use papermaking fibers from recycle sources. The amount of recycle fiber used in the papermaking fiber of the present invention is in no way limited and would be appropriately selected by the skilled artisan based upon the intended end use.

The paper product according to the present invention is produced by combining papermaking fibers and thermally bondable fibers. According to one embodiment of the present invention, the thermally bonded fibers are present in an amount of less than about 50%. According to another embodiment of the present invention, the thermally bonded fibers are present in an amount of less than about 30%. According to another embodiment of the present invention, the thermally bonded fibers are present in an amount of less than about 20%. According to still another embodiment of the present invention, the thermally bonded fibers are present in an amount of greater than about 2%. In yet another embodiment, the thermally bonded fiber is present in an amount of from 2% to about 20%. According to embodiments of the present invention, the remaining fiber is chosen from cellulose based fibers.

When producing a stratified product, it would be apparent to the skilled artisan that the amounts of thermally bondable fiber may be varied between the various stratified layers of the product. It would also be readily apparent that the amount of thermally bondable fiber can be increased or decreased in the various layers, beyond the amounts noted above, depending upon the desired end product. According to one embodiment, the product according to the present invention contains from about 20% to about 100% papermaking fiber in the Yankee side of a stratified product. According to another embodiment, the Yankee side of the stratified product contains substantially all papermaking fibers. In yet another embodiment, when polylactic acid containing fibers are used, the Yankee side of the stratified product contains substantial amounts of thermally bondable fiber.

The thermally bondable fiber may be combined with the papermaking fibers in any art recognized manner. The papermaking fiber may be dispersed with the thermally bondable fiber being added to that dispersion. The thermally bondable fiber may be dispersed with the papermaking fiber being added to that dispersion. Both the papermaking fiber and thermally bondable fiber may be dispersed together. Finally, the papermaking fiber may be dispersed and the thermally bondable fiber may be separately dispersed, with the fibers being added together from separate dispersions.

The fibers may be mixed using low intensity mixing or high intensity mixing. As used in the present invention, low intensity mixing refers to mixing under generally laminar flow conditions. As used in the present invention, high intensity mixing refers to mixing that occurs during turbulent flow conditions. The mixing is conducted for a period sufficient to attain reasonable dispersion of both the thermally bondable fibers and any papermaking fibers. According to another embodiment, mixing is carried out for a time sufficient to attain substantially complete dispersion of the thermally bondable and papermaking fibers.

The slurry of fibers may contain additional treating agents or additives to alter the physical properties of the paper product produced. These additives and agents are well understood by the skilled artisan and may be used in any known combination. Because strength and softness are desirable properties for paper products such as tissue, napkins and towels, the pulp can be mixed with strength adjusting agents, such as wet strength agents, temporary wet strength agents, dry strength agents, CMC, and debonders/softeners.

Suitable wet strength agents will be readily apparent to the skilled artisan. A comprehensive, but non-exhaustive list, of useful wet strength aids include aliphatic and aromatic aldehydes, urea-formaldehyde resins, melamine formaldehyde resins, polyamide-epichlorohydrin resins, and the like. According to one embodiment, the wet strength agents are the polyamide-epichlorohydrin resins, an example of which is sold under the trade names KYMENE 557LX and KYMENE 557H, by Hercules Incorporated of Wilmington, Del. These resins and the process for making the resins are described in U.S. Pat. No. 3,700,623 and U.S. Pat. No. 3,772,076, each of which is incorporated herein by reference. An extensive description of polymeric-epihalohydrin resins is given in Chapter 2: Alkaline-Curing Polvmeric Amine-Epichlorohydrin Resins by Espy in Wet-Strength Resins and Their Application (L. Chan, Editor, 1994), herein incorporated by reference. A non-exhaustive list of wet strength resins is described by Westfelt in Cellulose Chemistry and Technology, Volume 13, p. 813, 1979, which is incorporated herein by reference. According to one embodiment, the pulp contains up to about 30 lbs/ton of wet strength agent. According to another embodiment, the pulp contains from about 20 to about 30 lbs/ton of a wet strength agent.

Suitable temporary wet strength agents will be readily apparent to the skilled artisan. A comprehensive, but non-exhaustive, list of useful temporary wet strength agents includes aliphatic and aromatic aldehydes including glyoxal, malonic dialdehyde, succinic dialdehyde, glutaraldehyde and dialdehyde starches, as well as substituted or reacted starches, disaccharides, polysaccharides, chitosan, or reacted polymeric reaction products of monomers or polymers having aldehyde groups, and optionally, amine groups. Representative nitrogen containing polymers, which can suitably be reacted with the aldehyde containing monomers or polymers, include vinyl-amides, acrylamides, and related nitrogen containing polymers. These polymers impart a positive charge to the aldehyde containing reaction product. In addition, other commercially available temporary wet strength agents, such as, PAREZ 745, manufactured by Cytec, Bernardsville, N.J., can be used, along with those disclosed, for example in U.S. Pat. No. 4,605,702, which is incorporated herein by reference.

The temporary wet strength resin may be any one of a variety of water-soluble organic polymers comprising aldehydic units and cationic units used to increase dry and wet tensile strength of a paper product. Such resins are described in U.S. Pat. Nos. 4,675,394; 5,240,562; 5,138,002; 5,085,736; 4,981,557; 5,008,344; 4,603,176; 4,983,748; 4,866,151; 4,804,769; and 5,217,576, each of which is incorporated herein by reference. Modified starches sold under the trademarks CO-BOND® 1000 and CO-BOND® 1000 Plus, by National Starch and Chemical Company of Bridgewater, N.J., may be used. Prior to use, the cationic aldehydic water soluble polymer can be prepared by preheating an aqueous slurry of approximately 5% solids maintained at a temperature of approximately 240° F. and a pH of about 2.7 for approximately 3.5 minutes. Finally, the slurry can be quenched and diluted by adding water to produce a mixture of approximately 1.0% solids at less than about 130° F.

Other temporary wet strength agents, also available from National Starch and Chemical Company are sold under the trademarks CO-BOND® 1600 and CO-BOND® 2300. These starches are supplied as aqueous colloidal dispersions and do not require preheating prior to use.

Temporary wet strength agents such as glyoxylated polyacrylamide can be used. Temporary wet strength agents such as glyoxylated polyacrylamide resins are produced by reacting acrylamide with diallyl dimethyl ammonium chloride (DADMAC) to produce a cationic polyacrylamide copolymer which is ultimately reacted with glyoxal to produce a cationic cross-linking temporary or semi-permanent wet strength resin, glyoxylated polyacrylamide. These materials are generally described in U.S. Pat. No. 3,556,932 to Coscia et al. and U.S. Pat. No. 3,556,933 to Williams et al., both of which are incorporated herein by reference. Resins of this type are commercially available under the trade name of PAREZ 631NC, by Cytec Industries. Different mole ratios of acrylamide/DADMAC/glyoxal can be used to produce cross-linking resins, which are useful as wet strength agents. Furthermore, other dialdehydes can be substituted for glyoxal to produce wet strength characteristics. According to one embodiment of the invention, the pulp contains up to about 30 lbs/ton of temporary wet strength agent. According to another embodiment the pulp contains from about 0 to about 10 lbs/ton of a temporary wet strength agent.

Suitable dry strength agents will be readily apparent to one skilled in the art. A comprehensive, but non-exhaustive, list of useful dry strength agents includes starch, guar gum, polyacrylamides, carboxymethyl cellulose, and the like. According to one embodiment of the present invention, the dry strength agent is carboxymethyl cellulose, an example of which is sold under the trade name HERCULES CMC, by Hercules Incorporated of Wilmington, Del. According to another embodiment of the invention, the pulp contains from about 0 to about 15 lbs/ton of dry strength agent. According to yet another embodiment of the present invention, the pulp contains from about 1 to about 5 lbs/ton of dry strength agent.

Suitable debonders and softeners will also be readily apparent to the skilled artisan. These debonders and softeners may be incorporated into the pulp or sprayed upon the web after its formation. According to one embodiment, softening and debonding agents are added in an amount of not greater than about 2.0%, by weight. According to another embodiment, softening and debonding agents are added in amount of not greater than about 1.0%. According to yet another embodiment, softening and debonding agents are added in an amount of greater than about 0% to about 0.4%, by weight.

According to one embodiment of the present invention, the softener material is an imidazoline derived from partially acid neutralized amines. Such materials are disclosed in U.S. Pat. No. 4,720,383, which is incorporated herein by reference. Also relevant are the following articles: Evans, Chemistry and Industry, 5 Jul. 1969, pp. 893-903; Egan, J. Am. Oil Chemist's Soc., Vol. 55 (1978), pp. 118-121; and Trivedi et al., J. Am. Oil Chemist's Soc., June 1981, pp. 754-756. All of the above articles are herein incorporated by reference.

Softeners are often available commercially as complex mixtures rather than as single compounds. While this discussion will focus on the predominant species, it should be understood that commercially available mixtures could generally be used.

HERCULES 632, sold by Hercules, Inc., Wilmington, Del., is a suitable softener material, which may be derived by alkylating a condensation product of oleic acid and diethylenetriamine. Synthesis conditions using a deficiency of alkylation agent (e.g., diethyl sulfate) and only one alkylating step, followed by pH adjustment to protonate the non-ethylated species, result in a mixture consisting of cationic ethylated and cationic non-ethylated species. Since only a minor proportion (e.g., about 10%) of the resulting amino or amidol salt cyclize to imidazoline compounds, the major portion of these chemicals are pH sensitive.

Quaternary ammonium compounds, such as dialkyl dimethyl quaternary ammonium salts are also suitable, particularly when the alkyl groups contain from about 14 to 20 carbon atoms. These compounds have the advantage of being relatively insensitive to pH.

The present invention can also be used with a class of cationic softeners comprising imidazolines which have a melting point of about 0° C. to about 40° C. when formulated with aliphatic polyols, aliphatic diols, alkoxylated aliphatic diols, alkoxylated polyols, alkoxylated fatty acid esters, or a mixture of these compounds. The softener comprises an imidazoline moiety formulated in aliphatic polyols, aliphatic diols, alkoxylated aliphatic diols, alkoxylated aliphatic polyols, alkoxylated fatty acid esters, or a mixture of these compounds is dispersible in water at a temperature of about 1° C. to about 40° C.

The imidazolinium moiety may have the following chemical structures:

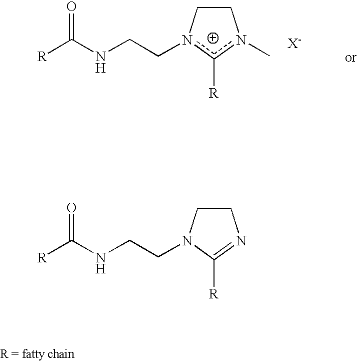

wherein X is an anion and R is selected from the group of saturated and unsaturated paraffinic moieties having a carbon chain length of C₁₂ to C₂₀. According to one embodiment, the carbon chain length is C₁₆-C₂₀. R1 is selected from the group of paraffinic moieties having a carbon chain length of C₁-C₃. Suitably, the anion is methyl sulfate, ethyl sulfate, or the chloride moiety. The organic component of the softener, other than the imidazoline, may be selected from aliphatic diols, alkoxylated aliphatic diols, aliphatic polyols, alkoxylated aliphatic polyols, alkoxylated fatty esters, esters of polyethylene oxides, or a mixture of these compounds having a weight average molecular weight of from about 60 to about 1500. The cold-water dispersed aliphatic diols may have a molecular weight of about 90 to about 150. According to another embodiment, the molecular weight of from about 106 to about 150. According to one embodiment of the present invention, the diol is 2,2,4 trimethyl 1,3 pentane diol (TMPD) and the alkoxylated diol is ethoxylated 2,2,4 trimethyl 1,3 pentane diol (TMPD/EO). Suitably, the alkoxylated diol is TMPD (EO)ₙ wherein n is an integer from 1 to 7, inclusive. Dispersants for the imidazoline moiety are alkoxylated aliphatic diols and alkoxylated polyols. Since it is hard to obtain pure alkoxylated diols and alkoxylated polyols, mixtures of diols, polyols, and alkoxylated diols, and alkoxylated polyols, and mixtures of only diols and polyols can be suitably utilized. A suitable imidazoline softener is sold by Hercules, Inc. of Wilmington, Del., under the trade name PROSOFT 230.

Biodegradable softeners can also be utilized. Representative biodegradable cationic softeners/debonders are disclosed in U.S. Pat. Nos. 5,312,522; 5,415,737; 5,262,007; 5,264,082; and 5,223,096, herein incorporated by reference. These compounds are biodegradable diesters of quaternary ammonia compounds, quaternized amine-esters, biodegradable vegetable oil based esters functionalized with quaternary ammonium chloride, and diester dierucyidimethyl ammonium chloride are representative biodegradable softeners.

Suitable additives can include particulate fillers which will be readily apparent to one skilled in the art. A comprehensive, but non-exhaustive, list of useful additives, such as particulate fillers, includes clay, calcium carbonate, titanium dioxide, talc, aluminum silicate, calcium silicate, calcium sulfate, and the like.

Suitable retention aids will be readily apparent to one skilled in the art. A comprehensive, but non-exhaustive, list of useful retention aids includes anionic and cationic flocculants.

Alternatively, instead of being incorporated into the pulp, these treating agents can be applied to the web. This may be accomplished through one or more applicator systems and can be to either one or both surfaces of the web. Application of multiple treating agents using multiple application systems helps to prevent chemical interaction of treating materials prior to their application to the web. Alternative configurations and application positions will be readily apparent to the skilled artisan.

Other additives that may be present in the fibrous slurry include sizing agents, absorbency aids, opacifiers, brighteners, optical whiteners, barrier chemistries, dyes, or colorants.

The fibrous slurry is deposited on the forming wire at a consistency of less than about 20%. According to another embodiment, the fibrous slurry is deposited on the forming wire at a consistency of less than about 5%. According to yet another embodiment, the fibrous slurry is deposited on the forming wire at a consistency of less than about 1%. In another embodiment, the fibrous slurry has a consistency of from about 0.01% to about 1%.

After deposition of the fibrous slurry onto the forming wire, the thus-formed wet fibrous web is typically transferred onto a dewatering felt or an impression fabric, which can create a pattern in the web, if desired. Any art recognized fabrics or felts can be used with the present invention. For example, a non-exhaustive list of impression fabrics includes plain weave fabrics described in U.S. Pat. No. 3,301,746; semi-twill fabrics described in U.S. Pat. Nos. 3,974,025 and 3,905,863; bilaterally-staggered-wicker-basket-cavity type fabrics described in U.S. Pat. Nos. 4,239,065 and 4,191,609; sculptured/load bearing layer type fabrics described in U.S. Pat. No. 5,429,686; photopolymer fabrics described in U.S. Pat. Nos. 4,529,480; 4,637,859; 4,514,345; 4,528,339; 5,364,504; 5,334,289; 5,275,799; and 5,260,171; and fabrics containing diagonal pockets described in U.S. Pat. No. 5,456,293. The aforementioned patents are incorporated herein by reference. Any art-recognized-felt can be used with the present invention. For example, felts can have double-layer base weaves, triple-layer base weaves, or laminated base weaves. A non-exhaustive list of press felts for use in the present invention includes those described in U.S. Pat. Nos. 5,657,797; 5,368,696; 4,973,512; 5,023,132; 5,225,269; 5,182,164; 5,372,876; and 5,618,612, all of which are incorporated herein by reference.

After transfer, the web, at some point, is passed through the dryer section, which causes substantial drying of the web. As described below, the web can be dried using conventional wet-pressing techniques, or may be produced using through-air-drying (TAD). If produced using TAD, the web may or may not be pressed to the surface of a rotating Yankee dryer cylinder to remove additional moisture within the web.

Other suitable processes include wet creping or through-air-drying with wet creping. Wet Creping is a process whereby the sheet is applied to a Yankee dryer at a reduced solids content. The sheet is creped from the Yankee dryer and then drying is completed using another drying method. Drying subsequent to the Yankee dryer can be carried out using any art recognized dryer including, but not limited to, one or more through-air-dryers, or can dryers.

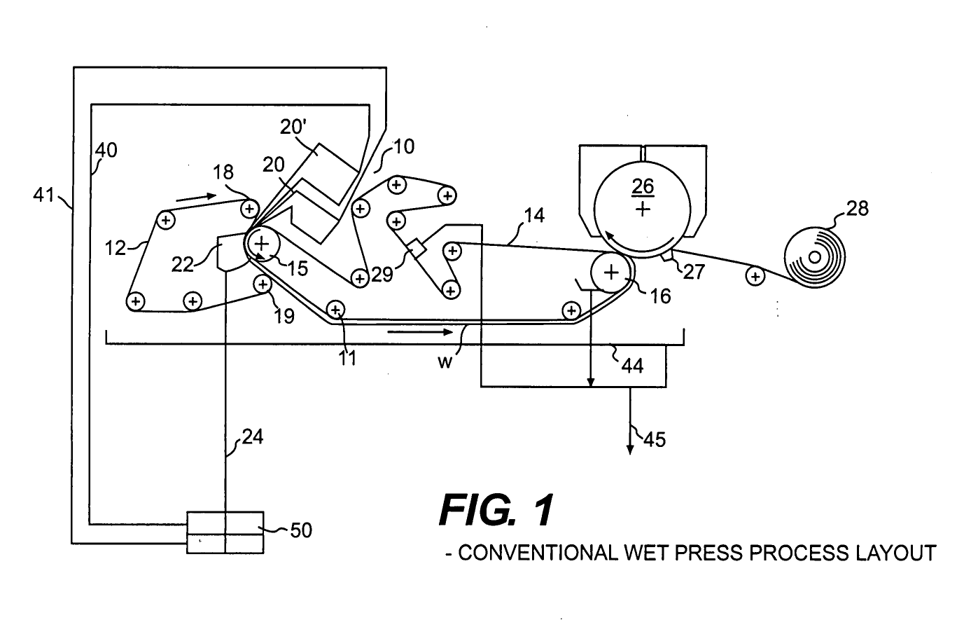

While the present invention can be used with any known dryer configuration, the most common drying methods are (I) conventional wet pressing (CWP) and (II) through-air-drying (TAD). In a conventional wet press process and apparatus (10), as exemplified in FIG. 1, a furnish is fed from a stuffbox (not shown) into conduits (40, 41) and then to headbox chambers (20, 20′). A web (W) is formed on a conventional wire former (12), which is supported by rolls (18, 19), from a liquid slurry of pulp, water, and other chemicals. Materials removed from the web through the fabric (12) in the forming zone are returned to a silo (50), from a saveall (22) through a conduit (24). The web is then transferred to a moving felt or fabric (14), which is supported by a roll (11), for drying and pressing. Materials removed from the web during pressing or from a Uhle box (29) are collected in a saveall (44) and fed to a white water conduit (45). The web is then pressed by a suction press roll (16) against the surface of a rotating Yankee dryer cylinder (26), which is heated to cause the paper to substantially dry on the Yankee dryer cylinder surface. Although not shown in FIG. 1, a shoe press could be used in place of the suction press roll to press the paper against the surface of the rotating Yankee dryer cylinder (26). The moisture within the web as it is laid on the Yankee surface causes the web to transfer to the surface. Sheet dryness levels immediately after the suction press roll may be in the range of about 30% to about 50% dryness. Liquid adhesive, often referred to as creping adhesive, may be applied to the surface of the dryer to provide substantial adherence of the web to the creping surface. The web is then creped from the surface with a creping blade (27) or a roller equipped with a fabric. Details of roll creping are generally described in U.S. Pat. Nos. 5,233,092 and 5,314,584, which are incorporated herein by reference in their entirety. The creped web is then optionally passed between calander rollers (not shown) and rolled up on a roll (28) prior to further converting operations, for example, embossing.

The surface speed of the reel can be faster or slower than the speed of the Yankee dryer. The level of creping is defined as the speed difference between the Yankee and the reel divided by the Yankee speed, expressed as a percentage. The action of the creping blade on the paper is known to cause a portion of the interfiber bonds within the paper to be broken up by the mechanical smashing action of the blade against the web as the web is being driven into the blade. However, fairly strong interfiber bonds are formed between the wood pulp fibers during the drying of the moisture from the web.

As used in the present invention, ““wet formed” means paper sheet products that have been made by formation of a nascent web on a foraminous forming fabric from a dispersed slurry of fibers. As used in the present invention wet formed” does not include products produced without the use of a headbox or those products produced at line speeds of less than 1000 ft/min. Nor does “wet formed” as used in this application, include the production of “fluff.” According to one embodiment of the invention, the line speeds for use with the present invention are in excess of 1500 ft/min.

A web may alternatively be subjected to vacuum deformation on an impression fabric, alone or in conjunction with other physical deformation processes, and a drying step, which dries the web to a solids content of at least about 30% without the need for overall physical compression. This type of process is conventionally referred to as a through-air-drying process or TAD process. This process is generally described in U.S. Pat. No. 3,301,746, to Sanford et al. and U.S. Pat. No. 3,905,863, to Ayers, which are incorporated herein by reference in their entirety.

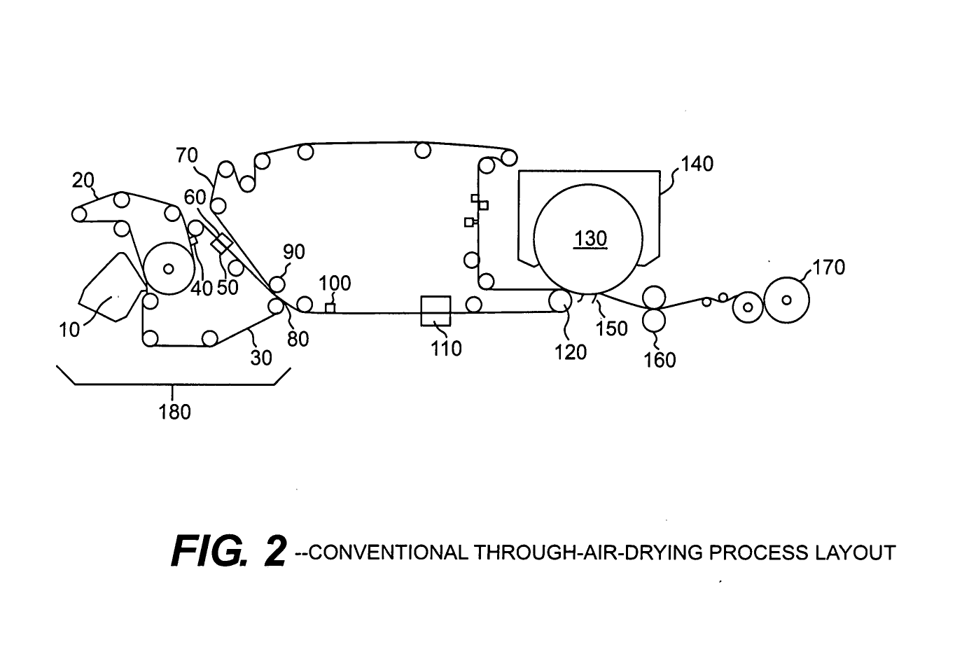

As an example, one conventional TAD process is illustrated in FIG. 2. In this process, fibers are fed from a headbox (10) to a converging set of forming wires (20,30). In this twin-wire forming arrangement, water is removed from the web by centrifugal forces and by vacuum means. The wet nascent web is cleanly transferred to forming wire (30) via a Uhle box (40). The web can be optionally processed to remove water by a vacuum box (50) and a steam shroud (60). The web is carried along the forming wire (30) until it is transferred to a TAD fabric (70) at a junction (80) by means of a vacuum pickup shoe (90). The web is further dewatered at the dewatering box (100) to increase web solids. Besides removing water from the web, the vacuum pickup shoe (90) and the dewatering box (100) inundate the web into the TAD fabric (70) causing bulk and absorbency characteristics.

Further enhancements in bulk and absorbency can be obtained by operating the speed of the forming section (i.e., the speeds of the forming fabrics (20) and (30)) faster than the speed of the TAD fabric (70). This is referred to as fabric creping. Fabric creping is defined mathematically as the difference in speed between the former and the through-air-dryer divided by the speed of the through-air-dryer, expressed as a percentage. In this manner, the web is inundated and wet shaped into the fabric, creating bulk and absorbency. The amount of fabric crepe may be from 0% to about 25%. Thickness created by wet shaping is more effective in generating absorbency (i.e., less structural collapse) than thickness created in the dry state, e.g., by conventional embossing.

The web is then carried on the TAD fabric (70) to a drying unit (110) where heated air is passed through both the web and the fabric to increase the solids content of the web. Generally, the web is from about 30% to about 95% dry after exiting the drying unit (110). In one process, the web may be removed directly from the TAD fabric (70) in an uncreped process. In the embodiment shown in FIG. 2, the web is transferred from the TAD fabric (70) to the Yankee dryer cylinder (130) and is creped from the dryer cylinder (130) via a creping blade (150), thus producing a creped product.

Creping may be carried out using any art recognized creping process. According to one embodiment of the present invention, creping is carried out using a Taurus creping blade. The patented Taurus blade is an undulatory creping blade disclosed in U.S. Pat. No. 5,690,788, presenting differentiated creping and rake angles to the sheet and having a multiplicity of spaced serrulated creping sections of either uniform depths or non-uniform arrays of depths. The depths of the undulations are above about 0.008 inches. U.S. Pat. No. 5,690,788 is herein incorporated by reference in its entirety.

Creping of the web from the Yankee dryer can be facilitated through the use of a creping adhesive. Creping adhesives for use in the present invention can be selected from any art recognized creping adhesive. It would be readily apparent to the skilled artisan how to modify the creping package and/or creping angle, etc., based upon the melt profile of the thermally bondable fiber that is used. According to one embodiment of the present invention, creping adhesives for use according to the present invention include thermosetting or non-thermosetting resins.

Resins for use according to one embodiment of the present invention may be chosen from thermosetting and non-thermosetting polyamide resins or glyoxylated polyacrylamide resins. Polyamides for use in the present invention can be branched or unbranched, saturated or unsaturated. Polyamide resins for use in the present invention may include polyaminoamide-epichlorohydrin (PAE) resins. PAE resins are described, for example, in “Wet-Strength Resins and Their Applications,” Ch. 2, H. Epsy entitled Alkaline-Curing Polymeric Amine-Epichlorohydrin Resins, which is incorporated herein by reference in its entirety. Preferred PAE resins for use according to the present invention include a water-soluble polymeric reaction product of an epihalohydrin, preferably epichlorohydrin, and a water-soluble polyamide having secondary amine groups derived from a polyalkylene polyamine and a saturated aliphatic dibasic carboxylic acid containing from about 3 to about 10 carbon atoms.

A non-exhaustive list of non-thermosetting cationic polyamide resins for use in the present invention can be found in U.S. Pat. No. 5,338,807, issued to Espy et al. and incorporated herein by reference. The non-thermosetting resin may be synthesized by directly reacting the polyamides of a dicarboxylic acid and methyl bis(3-aminopropyl)amine in an aqueous solution, with epichlorohydrin. The carboxylic acids can include saturated and unsaturated dicarboxylic acids having from about 2 to 12 carbon atoms, including for example, oxalic, malonic, succinic, glutaric, adipic, pilemic, suberic, azelaic, sebacic, maleic, itaconic, phthalic, and terephthalic acids. Adipic and glutaric acids are preferred, with adipic acid being the most preferred. The esters of the aliphatic dicarboxylic acids and aromatic dicarboxylic acids, such as the phathalic acid, may be used, as well as combinations of such dicarboxylic acids or esters.

In an alternative embodiment, thermosetting polyamide resins for use in the present invention may be made from the reaction product of an epihalohydrin resin and a polyamide containing secondary amine or tertiary amines. In the preparation of a resin according to this embodiment of the invention, a dibasic carboxylic acid is first reacted with the polyalkylene polyamine, optionally in aqueous solution, under conditions suitable to produce a water-soluble polyamide. The preparation of the resin is completed by reacting the water-soluble amide with an epihalohydrin, particularly epichlorohydrin, to form the water-soluble thermosetting resin.

According to one embodiment of the present invention, the creping adhesive is a PAE resin with PVOH and a modifier. Art recognized modifiers will be readily apparent to the skilled artisan. When thermally bondable fibers contact the Yankee surface, a more aggressive adhesive may be used.

After the paper web has been produced, it is often reeled to await further processing toward an end product. This further processing is generally referred to as converting. While converting operations are generally carried out on reeled paper webs, the converting operations can also be added directly to the end of the manufacturing process. Converting includes, but is not limited to operations such as calandering, embossing, plying, the application of treatment agents, and heat treating. The product according to the present invention can be subjected to any of the art recognized converting operations which will be readily apparent to the skilled artisan.

Embossing is the act of mechanically working a substrate to cause the substrate to conform under pressure to the depths and contours of a patterned embossing roll. Generally, the web is passed between a pair of emboss rolls that, under pressure, form contours within the surface of the paper.

In most configurations at least one of the two roller surfaces directly carries the pattern to be transferred to the paper web. Known configurations include rigid-to-resilient embossing and rigid-to-rigid embossing.

In a rigid-to-resilient embossing system, a single or multi-ply substrate is passed through a nip formed between a roll whose substantially rigid surface contains the embossing pattern as a multiplicity of protuberances and/or depressions arranged into an aesthetically-pleasing manner, and a second roll, whose substantially resilient surface can be either smooth or also contain a multiplicity of protuberances and/or depressions which cooperate with the rigid surfaced patterned roll. Heretofore, rigid rolls were generally formed from a steel body which is either directly engraved upon or which can contain a hard rubber-covered surface (directly coated or sleeved) upon which the embossing pattern is laser engraved. While a steel roll that has been directly engraved has a longer lifespan, the production of a directly engraved steel roll can require a significant lead time. Known laser engraved sleeves can take less time to make but have a lifespan which is substantially less than that of a steel roll.

Resilient rolls may consist of a steel core directly coated or sleeved with a resilient material and may or may not be engraved with a pattern. If a pattern is present, it may be either a mated or a non-mated pattern with respect to the pattern carried on the rigid roll.

In the rigid-to-rigid embossing process, a single-ply or multi-ply substrate is passed through a nip formed between two substantially rigid rolls. The surfaces of both rolls contain the pattern to be embossed as a multiplicity of protuberances and/or depressions arranged into an aesthetically-pleasing manner where the protuberances and/or depression in the second roll cooperate with those patterned in the first rigid roll. The first rigid roll is generally formed from a steel body which is either directly engraved upon or which can carry a hard rubber-covered surface (directly coated or sleeved) upon which the embossing pattern is laser engraved. The second rigid roll is generally formed from a steel body which is also directly engraved upon or which can carry a hard rubber covered surface (directly coated or sleeved) upon which a matching or mated pattern is conventionally engraved or laser engraved.

The product according to the present invention can be embossed using any art recognized or after developed embossing pattern. The embossing process can be used not only to increase bulk and absorbance, but also to ply the product. Embossing is also used to improve the aesthetic appearance of the paper sheet product.

According to one embodiment of the present invention, due to the presence of the thermally bondable fibers in the product according to the present invention, the product can be heat treated to cause the fibers to bond, thereby, in effect, setting the product. Heat treatment can be carried out at any point during or after the drying process. According to one embodiment, heat treatment and bonding is carried out on the Yankee dryer. According to another embodiment of the present invention, heat treatment is carried on a TAD after the Yankee dryer. According to another embodiment of the present invention, heat treatment is carried out in a separate converting operation. When carried out as a separate converting operation, the product may be heated on a through-air-dryer, and/or in an TAD oven, and/or IR oven, and/or by heated calander rolls. More than one heat treatment or more than one type of heat treatment may be carried out on a single product depending upon the desired characteristics of the end product.

Heat treatment may be carried out before or after other converting operations. According to one embodiment of the present invention, heat treatment is carried out before or after embossing to set the emboss pattern. When fibers having an appropriate melt profile are used, the heat treatment can be carried out on the Yankee dryer during the drying process.

The heat treatment is carried out at a temperature capable of softening the outside of the thermally bondable fiber thereby rendering it bondable with the surrounding thermally bondable and papermaking fibers. According to one embodiment of the present invention, the heat treatment is carried out at a temperature of at least about 200° F. According to another embodiment of the present invention, the heat treatment is carried out at a temperature of at least about 260° F. According to another embodiment of the invention, the heat treatment is carried out at a temperature of at least about 270° F. According to another embodiment of the invention, the heat treatment is carried out at a temperature of at least about 310° F. According to another embodiment of the invention, the heat treatment is carried out at a temperature of between about 270° F. and about 360° F.

Prior to any heat treatment of the product, the product can be repulped and is fully dispersible. After heat treatment, while the cellulosic fiber may be substantially repulpable, the thermally bondable fibers may form a nondispersible network of fibers. After heat treatment, the thermally bondable fibers may be repulpable if specially treated to release the bonds between the thermally bondable materials and other cellulosic fibers.

The product produced according to the present invention may be any flat paper applications. Such products include, but are not limited to, tissues, towels, wipers, napkins, meat liners, packaging materials, writing paper, wallpaper, air filters, oil filters, and other absorbent products that may be or may not be subject to abrasion.

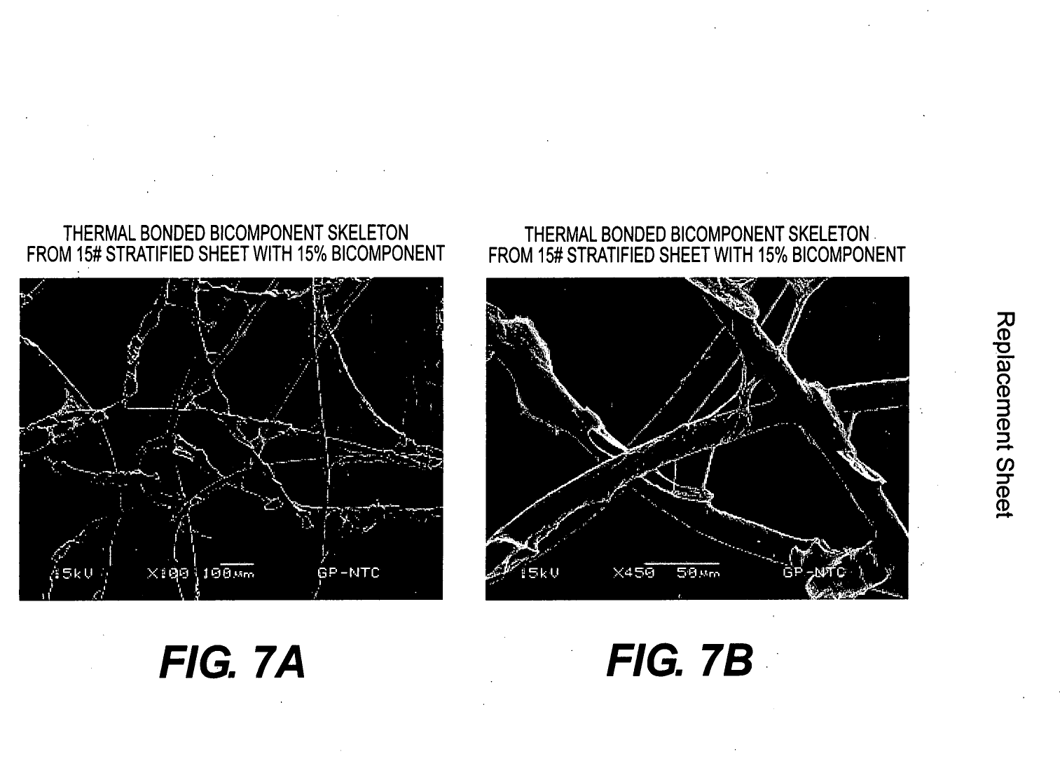

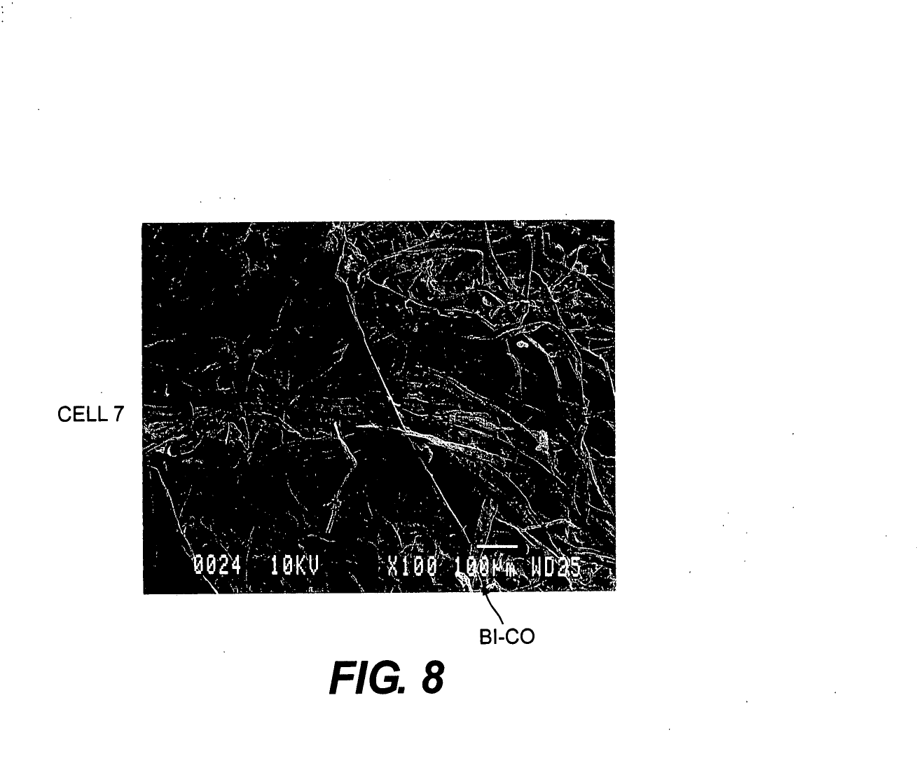

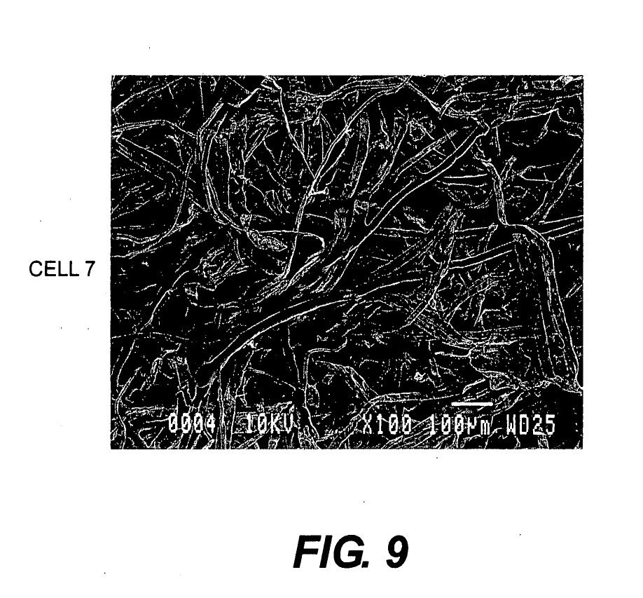

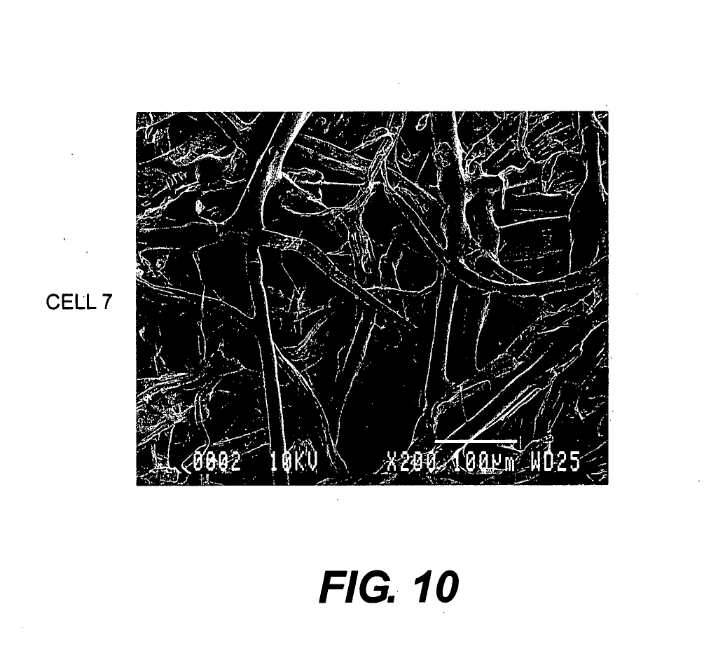

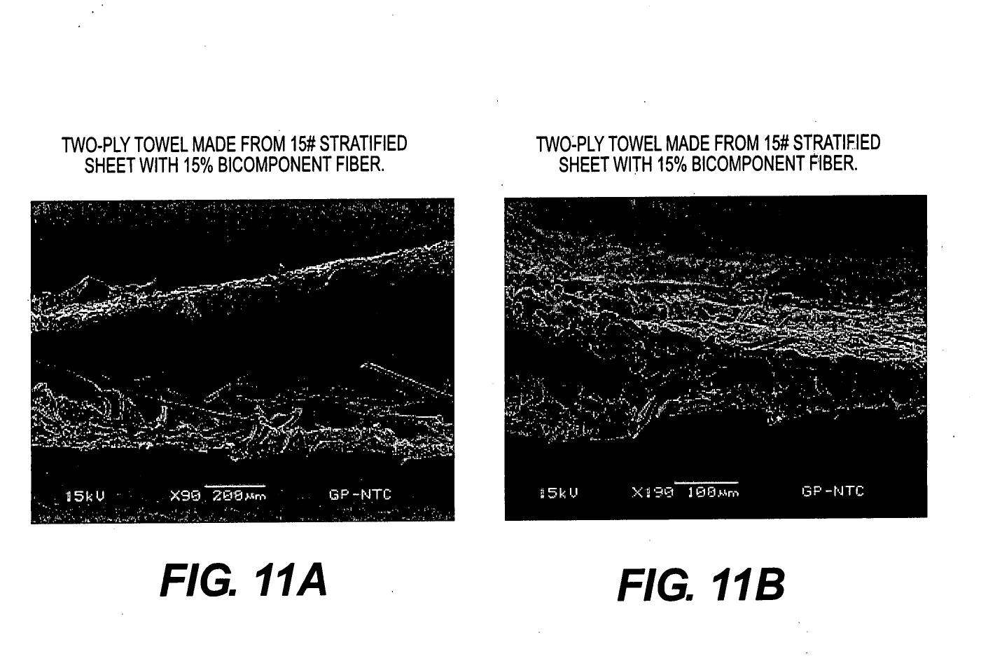

Products produced according to the present invention generally have a basis weight of from about 10 to about 60 lbs/ream. According to another embodiment, the products produced according to the present invention have a basis weight of from about 13 to about 40 lbs/ream. As used herein, a ream is 3000 ft². Paper products as produced according to the present invention may be recognized by the reticulated matrix of thermally bondable fibers that appear throughout the product. As used in the present invention, reticulated matrix is defined as a stable network structure. FIGS. 7-11 illustrate one reticulated matrix, alone or in bonded combination with papermaking fibers. FIGS. 11A and 11B illustrate one stratified product with a reticulated matrix.

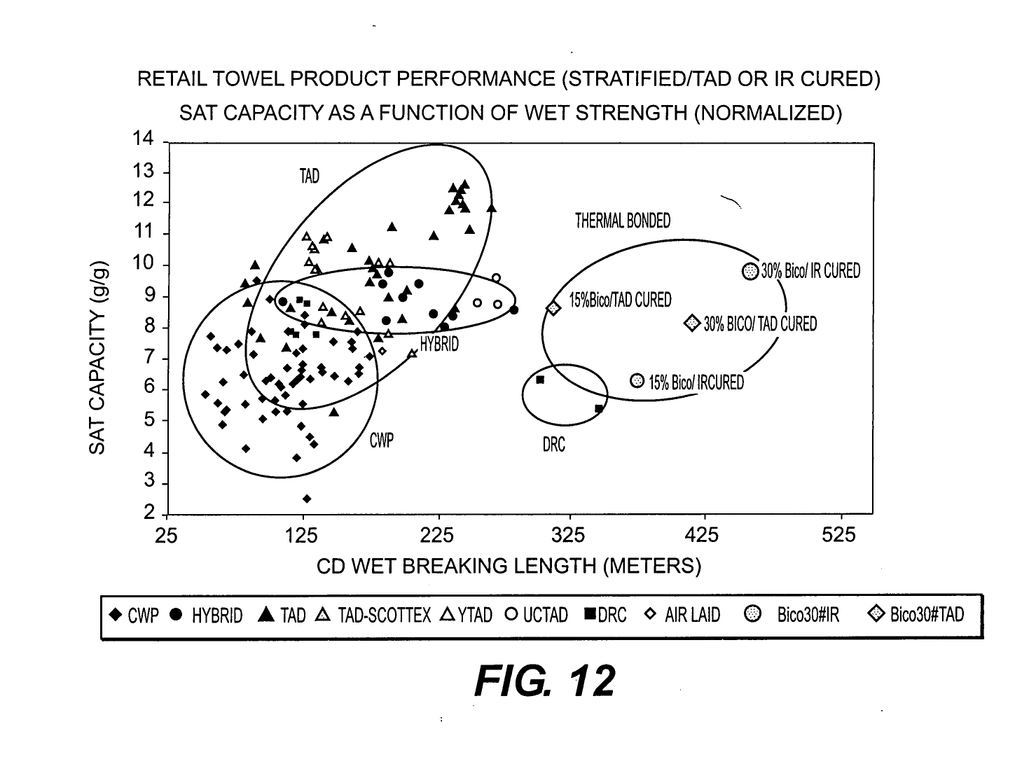

Products according to the present invention can exhibit one or more of the following improved qualities: wet tensile, abrasion resistance, wet bulk, resiliency, and absorbency. FIG. 12 illustrates SAT capacity as a function of normalized wet strength.

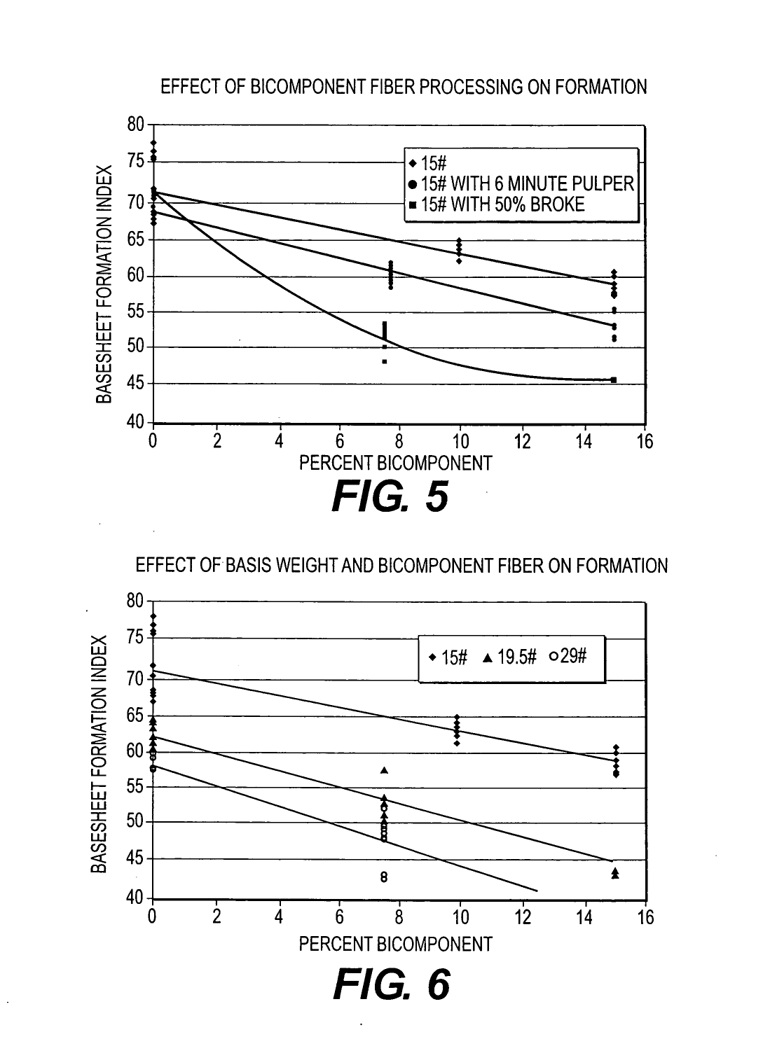

Formation refers to the uniformity with which fibers form a sheet. As used in the present invention formation can be defined by either formation index or crowding factor. Crowding factor is described for example in Dodson, “Fiber crowding, fiber contacts and fiber flocculation,” Vo. 79, No. 9, TAPPI Journal, September 1996, and Kerekes et al., “Characterization of Fibre Flocculation Regimes by a Crowding Factor,” Pulp and Paper report PPR 795, Pulp and Paper Research Institute of Canada, which are incorporated herein by reference. The relationship between formation index and the amount of thermally bondable bicomponent fiber is illustrated in FIG. 5. FIG. 6 illustrated the effect of basis weight changes on formation as a function of the amount of thermally bondable fiber present in the product.

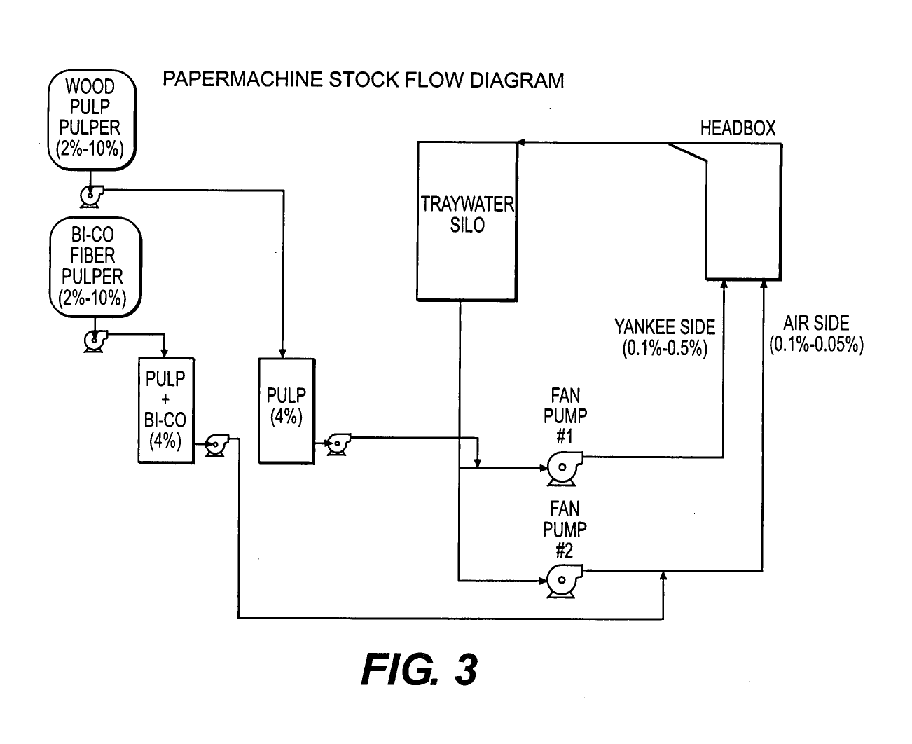

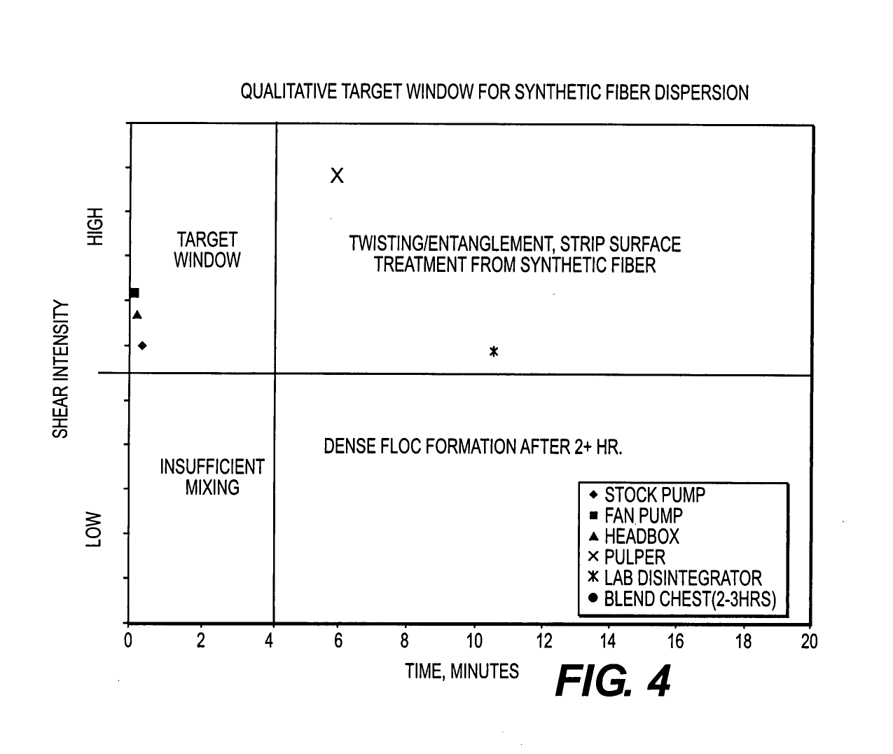

Suitable addition points for the thermally bondable fiber will be readily apparent to the skilled artisan. Appropriate points of addition can include, but are not limited to, in the pulper, after the pressure screen, before the fan pump, in the stock storage chest, and before the stock pump. One embodiment of a paper machine stock flow for use according to the present invention is illustrated in FIG. 3. FIG. 4 illustrates various dispersion methods and their relative effect on dispersion of thermally bondable fibers

Apparatus for use in the present invention may be modified to better accommodate the thermally bondable fibers. According to one embodiment of the present invention, the standard hole screen frequently used on papermaking machines may be replaced with a slotted screen to allow easier passage by the thermally bondable fibers.

The following examples are merely illustrative and are in no way limiting of the invention as presently claimed.

### EXAMPLES

### Examples 1-20

Handsheets containing synthetic fiber were made under varying conditions including varying pulp type, pulp/synthetic blend percentage, synthetic type, dispersion consistency, agitation time, agitation intensity, and formation consistency. The two synthetic fibers used were 6 mm CELBOND 105 bicomponent fiber and 3 mm LYOCELL rayon fiber as the control. The two wood pulps used were Marathon (MAR) softwood kraft and Old Town (OT) hardwood kraft. The sheets were all reviewed for formation index. Formation index uses visible light transmission and image analysis to measure handsheet uniformity. High values (100+) indicate excellent formation while lower values indicate poorer formation. The handsheets were produced in the same manner, except for the changes noted in Table 2. The fiber type, blend percentages, dispersion consistency, agitation timer, and agitation intensity were varied. The formation consistency and the formation index are reported.

TABLE 2

| | | Blend (%) of | Synthetic | Time | Dispersion | Formation | | Formation |
|---|---|---|---|---|---|---|---|---|
| Exp. | Pulp | Synthetic | Fiber | (Min) | (%) | (%) | Intensity | Index |
| 1 | OT | 0 | — | 20 | 3 | 0.0173 | Low | 103 |
| 2 | OT | 0 | — | 1 | 0.7 | 0.0173 | Low | 102.6 |
| 3 | Mar | 0 | — | 20 | 3 | 0.0173 | Low | 97.2 |
| 4 | Mar | 0 | — | 1 | 0.7 | 0.0173 | Low | 96.0 |
| 5 | Mar | 60 | Celbond | 20 | 3 | 0.15 | High | 46.2 |
| 6 | Mar | 60 | Celbond | 10 | 0.7 | 0.0173 | Low | 75.4 |
| 7 | Mar | 60 | Lyocell | 1 | 3 | 0.15 | Low | 65.3 |
| 8 | Mar | 60 | Lyocell | 20 | 0.7 | 0.0173 | High | 98.4 |
| 9 | Mar | 30 | Lyocell | 1 | 0.7 | 0.15 | High | 73.3 |
| 10 | Mar | 30 | Lyocell | 20 | 3 | 0.0173 | Low | 97.0 |
| 11 | Mar | 30 | Celbond | 20 | 0.7 | 0.15 | Low | 52.4 |
| 12 | Mar | 30 | Celbond | 1 | 3 | 0.0173 | High | 87.5 |
| 13 | OT | 30 | Celbond | 20 | 0.7 | 0.0173 | High | 91.8 |
| 14 | OT | 30 | Celbond | 1 | 3 | 0.15 | Low | 57.0 |
| 15 | OT | 30 | Lyocell | 1 | 0.7 | 0.0173 | Low | 104.2 |
| 16 | OT | 30 | Lyocell | 20 | 3 | 0.15 | High | 82.6 |
| 17 | OT | 60 | Lyocell | 1 | 3 | 0.0173 | High | 101.5 |
| 18 | OT | 60 | Lyocell | 20 | 0.7 | 0.15 | Low | 88.8 |
| 19 | OT | 60 | Celbond | 20 | 3 | 0.0173 | Low | 90.7 |
| 20 | OT | 60 | Celbond | 1 | 0.7 | 0.15 | High | 60.0 |

### Examples 21-28

Handsheets were made with 1.2 g of fiber at 0.05% consistency. The handsheet cylinder was filled to 2400 ml to achieve consistency. Handsheets made with 100% CELBOND used 2.5 g of fiber in order to form a continuous sheet.

Synthetic/pulp blend percentages and agitation timer were varied under high shear mixing conditions. The synthetic fiber used was CELBOND 105 bicomponent fiber at 6 mm and 3 denier. The batch size was 2300 ml at 5% consistency. Variations are described in Table 3, below. For examples labeled “together,” the CELBOND 105 and Old Town (OT) were pulped together. For examples labeled “separate,” the Old Town is pulped for the specified time, followed by synthetic fiber addition and blending.

TABLE 3

| | | | Old | 5% | Pulp | Pulp | Pulp | |
|---|---|---|---|---|---|---|---|---|
| | Celbond | Celbond | Town | OT | Time | Time | Time | |
| Exp. | (%) | (g) | (g) | (g) | 1 | 2 | 3 | Method |
| 21 | 0 | 0 | 115.0 | 2300 | 10 | 15 | 5 | — |
| 22 | 23 | 25.9 | 89.1 | 1783 | 10 | 15 | 5 | together |
| 23 | 45 | 51.8 | 63.3 | 1265 | 10 | 15 | 5 | together |
| 24 | 23 | 25.9 | 89.1 | 1783 | 10 | 0 | 5 | separate |
| 25 | 45 | 51.8 | 63.3 | 1265 | 10 | 0 | 5 | separate |
| 26 | 23 | 25.9 | 89.1 | 1783 | 10 | 15 | 5 | separate |
| 27 | 45 | 51.8 | 63.3 | 1265 | 10 | 15 | 5 | separate |
| 28 | 100 | 115.0 | 0 | 0 | 10 | 15 | 5 | — |

### Example 29

Wet-formed webs having a basis weight of 32 lbs/ream comprising 15% and 25% of 3 denier by 6 mm bicomponent fiber were produced with an incline former. The remainder of the web was a 40/60 blend of Naheola softwood and hardwood pulp, i.e., 36.4 lbs of 85% 40/60 blend of Naheola softwood and hardwood pulp in the machine chest with 1000 gallons of water. When the softwood/hardwood pulp was well dispersed (approximately 15 minutes) 6.45 lbs of 3 denier by 6 mm bicomponent fiber was added to the chest. The pulp slurry was gently agitated until the bicomponent fiber was well dispersed (approximately 15 minutes).

The stock in the headbox was diluted to a consistency of 0.05% or less. The reel basis weight was set at 32 lbs/ream and the moisture was set at 6%. 12 lbs/ton of wet strength resin was added to the suction side of the machine chest discharge pump.

### Example 30

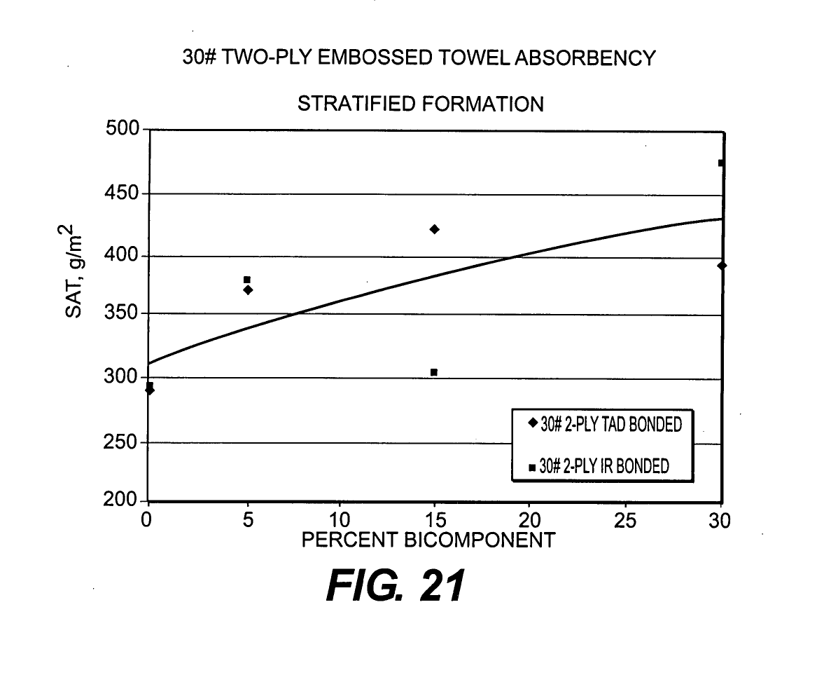

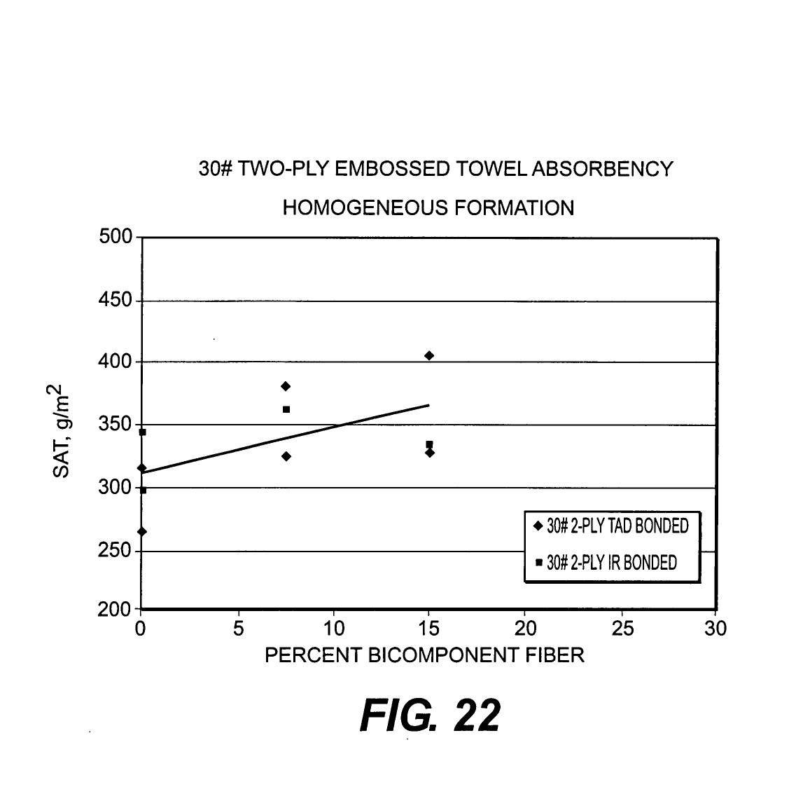

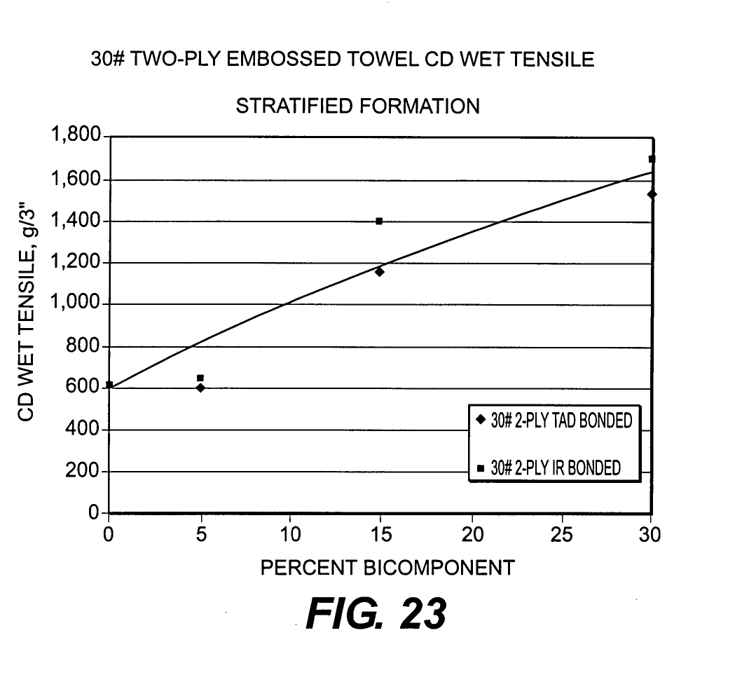

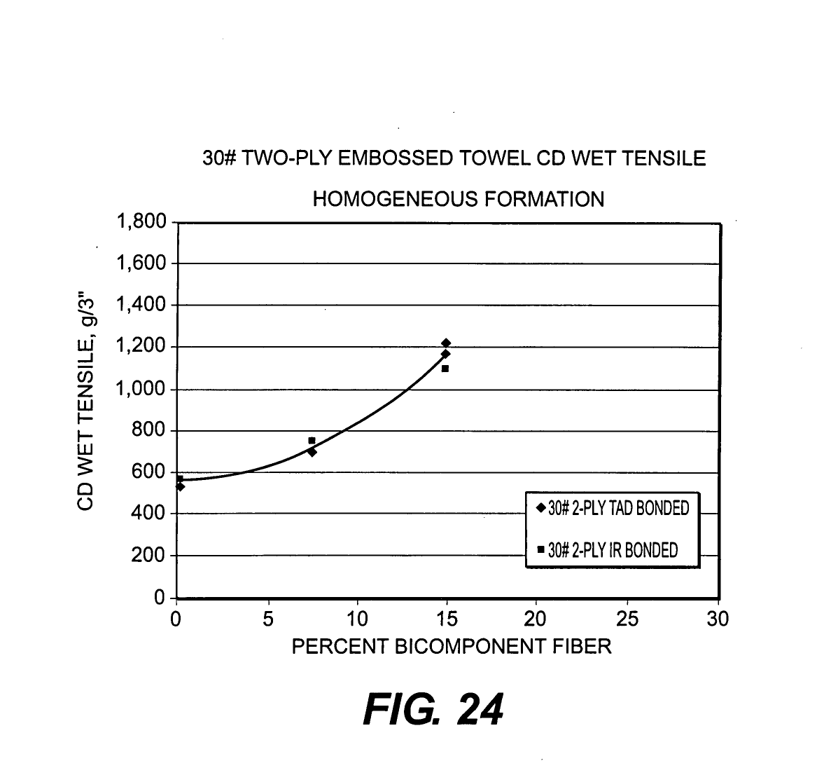

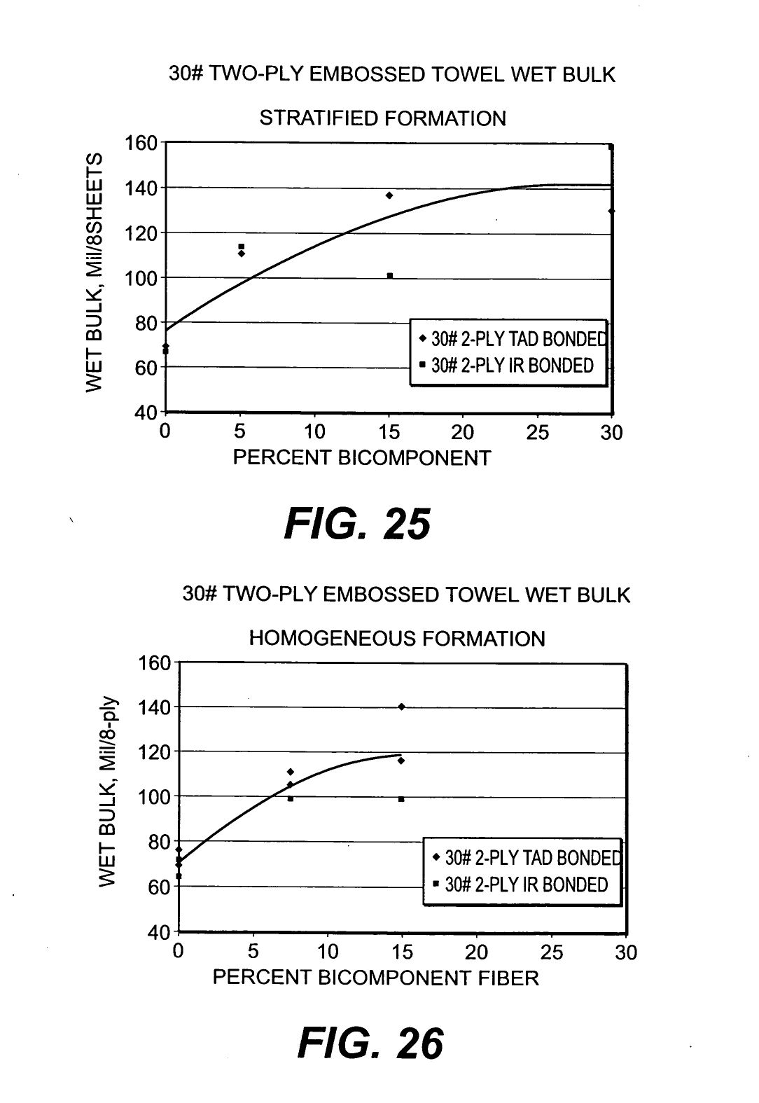

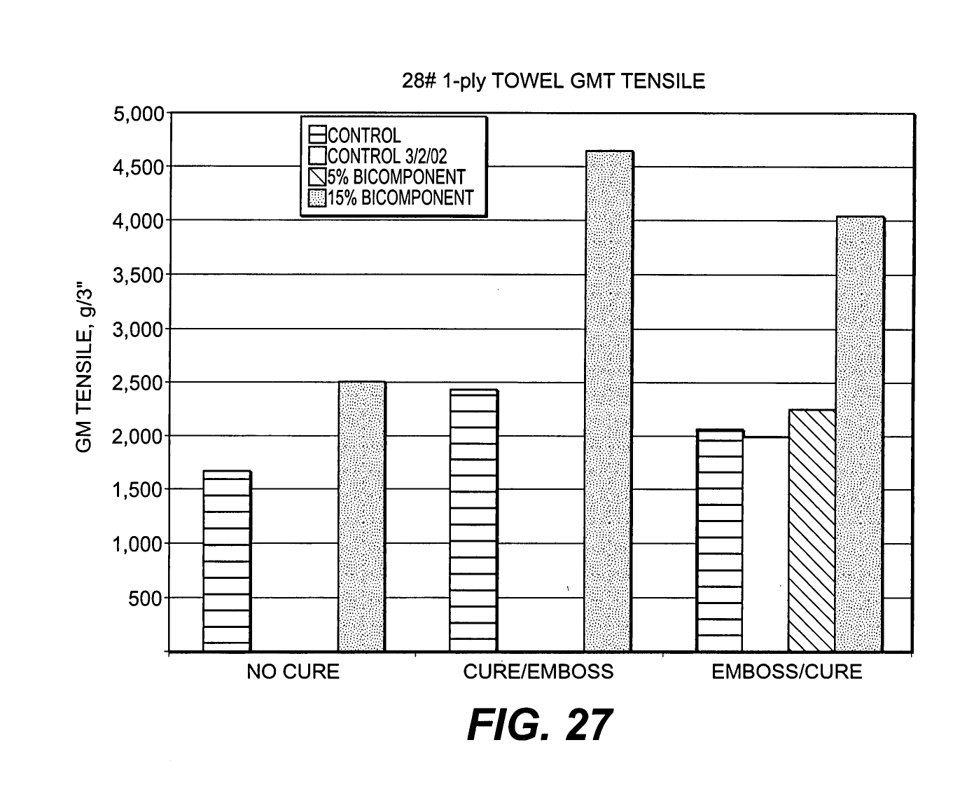

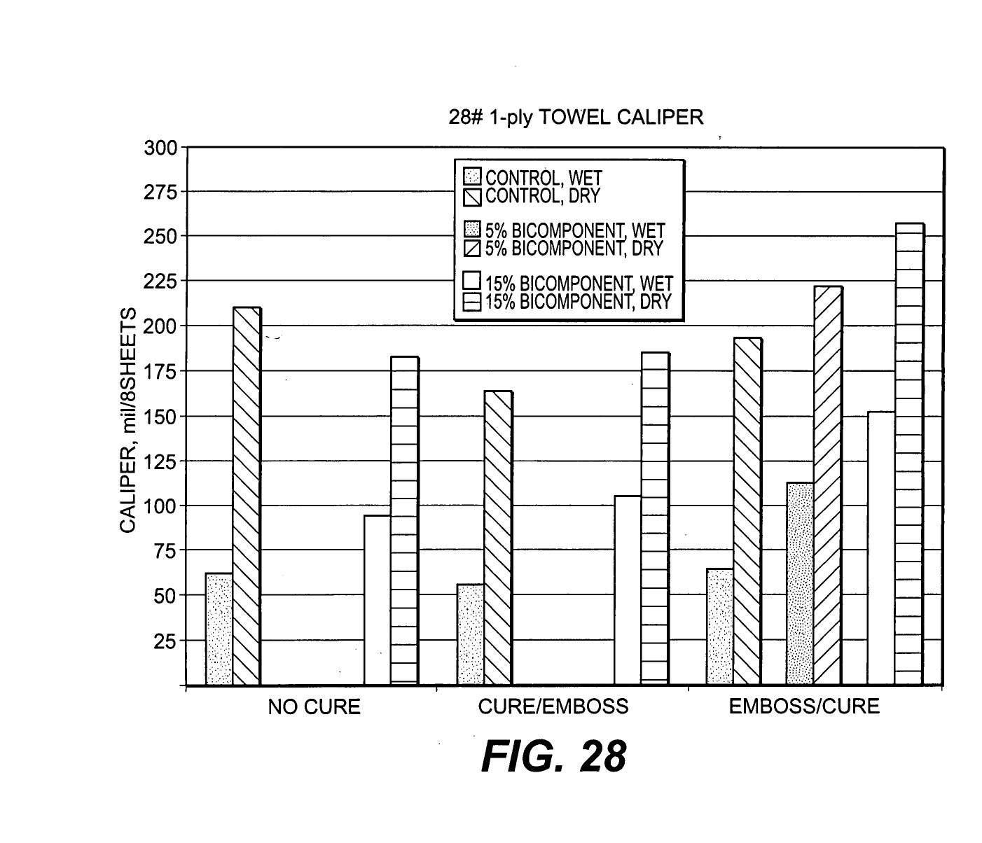

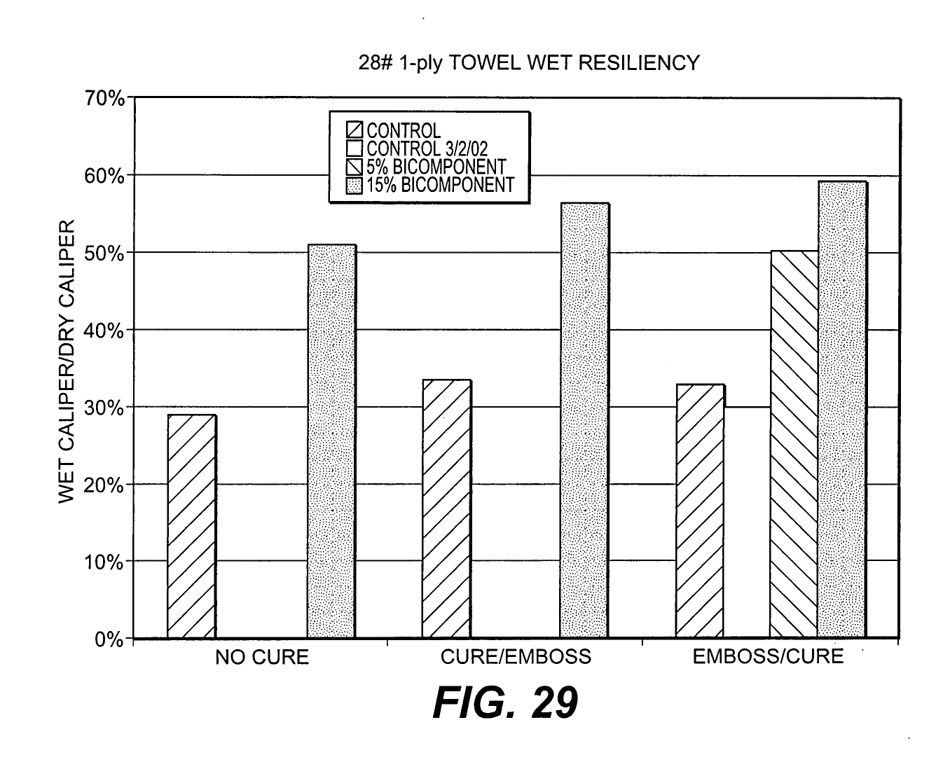

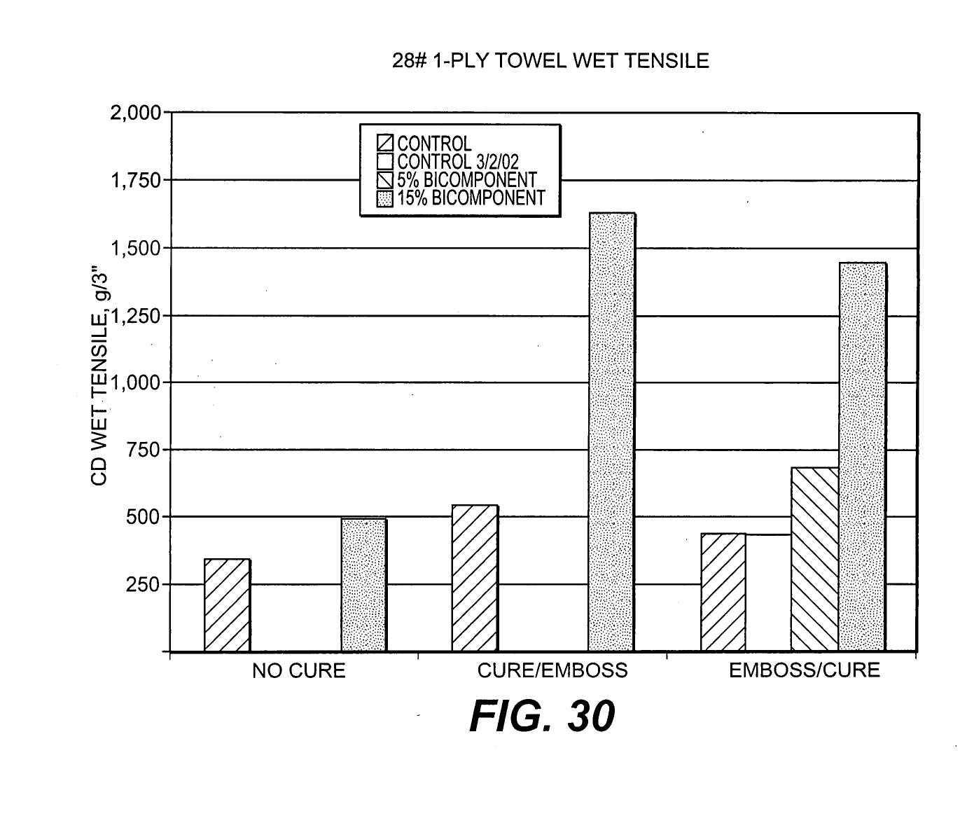

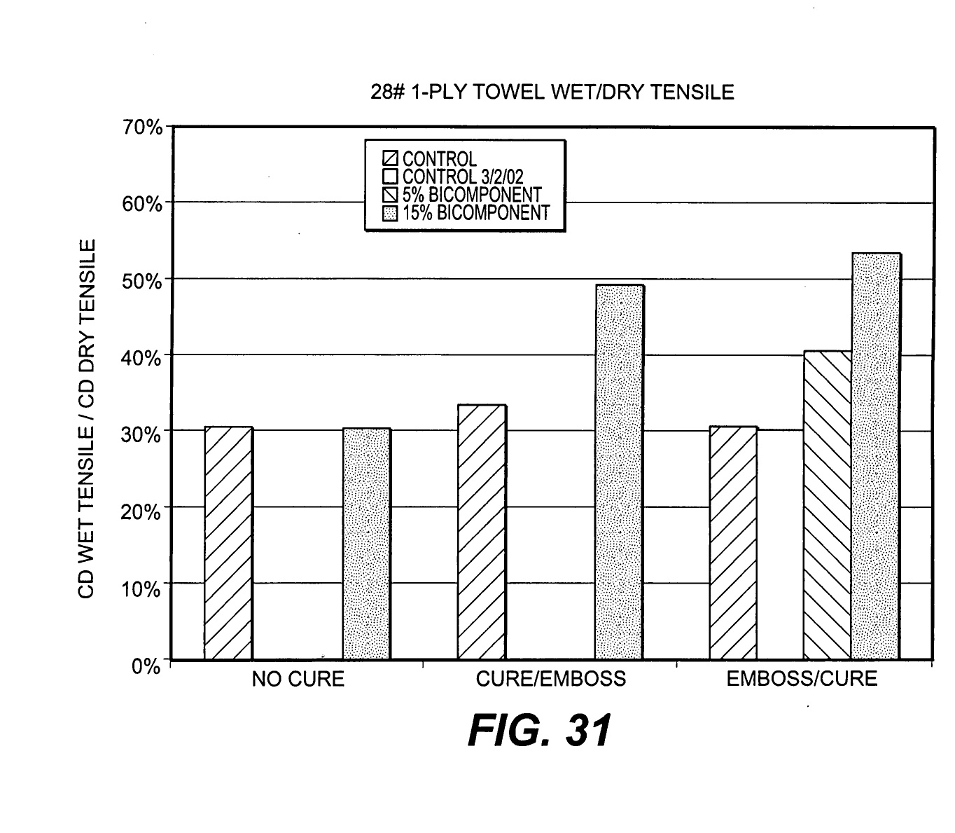

Sheet material was produced from a papermaking fiber and a bicomponent fiber. The bicomponent fiber was a 3 denier, 6 mm bicomponent fiber. The papermaking fiber was a 40/60 blend of Naheola softwood and hardwood pulp. When a homogeneous product was formed, the papermaking fiber and the bicomponent fiber were both added to the pulper. The bicomponent was added in amounts of 0, 7.5, and 15%. When a stratified product was formed, the bicomponent was added to the pulp slurry in the storage chest. The combined slurry was introduced before the pressure screen. (See FIG. 3) When a stratified product was produced, the bicomponent fiber was added in amounts of 0, 5, 15, and 30%. Any variations in sheet composition are noted in FIGS. 21-31. The controls used in this example contained no thermally bondable fiber. The sheets were cured using either a through-air-dryer or by exposure to infrared. The cured sheets were analyzed for SAT in g/m², CD Wet Tensile in g/3″, and Wet Bulk in mil/8-ply each as a function of the amount of thermally bondable fiber in the sheet. These results are set forth in FIGS. 21-26.

### Example 31

TAD handsheets were produced with 100% dry lap Marathon softwood handsheets and also with dry lap Marathon softwood including 10% bicomponent fiber. Two bicomponent fibers of different fiber lengths were used in the present study, 0.5-inch and 0.25-inch. Bicomponent fibers improved the strength and absorbent properties of TAD handsheets.

TAD handsheets containing bicomponent fiber were evaluated for strength, absorbency, and caliper. The handsheets were made using a TAD Simulator. Bicomponent fiber (0.5-inch and 0.25-inch) was mixed with Marathon softwood dry lap before handsheet making. The experimental cells used in the present experiment are described in Table 4.

TABLE 4
Experimental Cells

| Furnish - Dry Lap | | |
|---|---|---|
| Marathon SW | Furnish - Bicomponent | TAD Fabric |
| 100% Unrefined - 724 CSF | — | 100-mesh wire |
| | | Voith 44G |
| 100% Refined - 588 CSF | — | 100-mesh wire |
| | | Voith 44G |
| 90% Unrefined - 724 CSF | 10% 0.5″ | 100-mesh wire |
| | | Voith 44G |
| 90% Refined - 588 CSF | 10% 0.5″ | 100-mesh wire |
| | | Voith 44G |
| 90% Unrefined - 724 CSF | 10% 0.25″ | 100-mesh wire |
| | | Voith 44G |
| 90% Refined - 588 CSF | 10% 0.25″ | 100-mesh wire |
| | | Voith 44G |

The Marathon SW dry lap was refined to two levels of freeness using a PFI mill. Table 4 lists the Canadian Standard Freeness values for the furnish. Kymene 557H was added at 20 lb/T, and Hercules CMC 7MT was added at 3.4 lb/T to thick stock at 1.5% consistency before handsheet-making. During the present experiment, handsheets were formed in two ways: 1) on a 100-mesh wire and dried on the TAD Simulator using a second 100-mesh wire (unshaped web) and 2) on a 100-mesh wire and transferred to a Voith 44G TAD fabric to form a non-compacted shaped web. Handsheets shaped on a Voith 44G TAD fabric have higher caliper, and absorbency levels than unshaped handsheets dried on a 100-mesh screen.

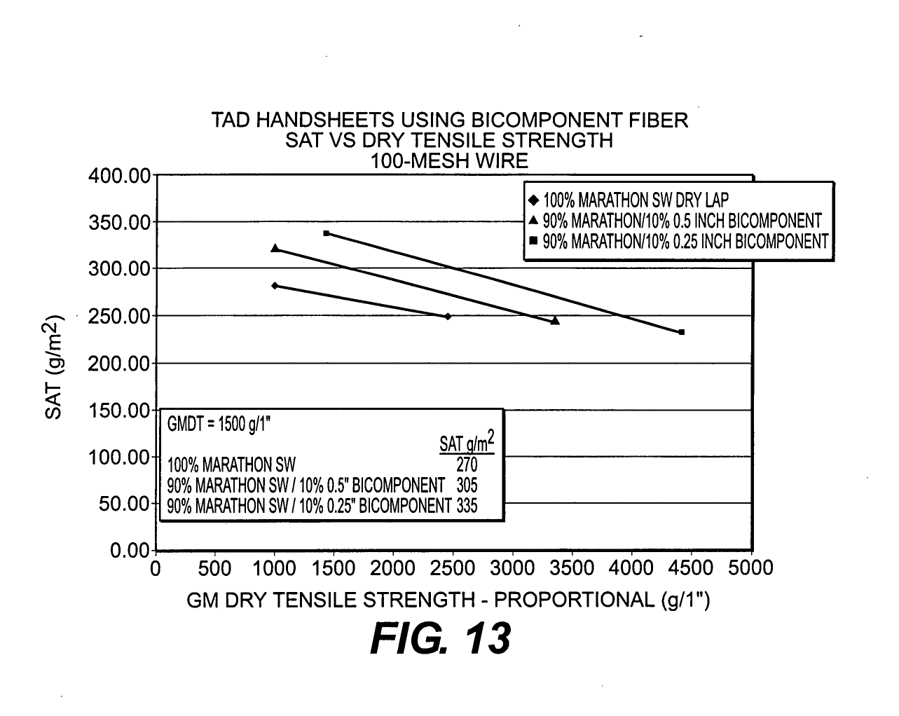

Bicomponent fibers cause improvements in absorbency, caliper and strength of TAD handsheets, whether dried on a 100-mesh screen (unshaped) or with a Voith 44G TAD fabric (shaped). Note that handsheets dried and shaped on the Voith 44G TAD fabric have higher levels of absorbency than handsheets dried on a 100-mesh screen. See FIG. 13.

Bicomponent fibers cause substantial improvements in wet/dry tensile strength ratios (i.e., 2×). As a result, target wet tensile strength properties can be achieved at lower dry tensile strength levels, ultimately leading to softer towel products.

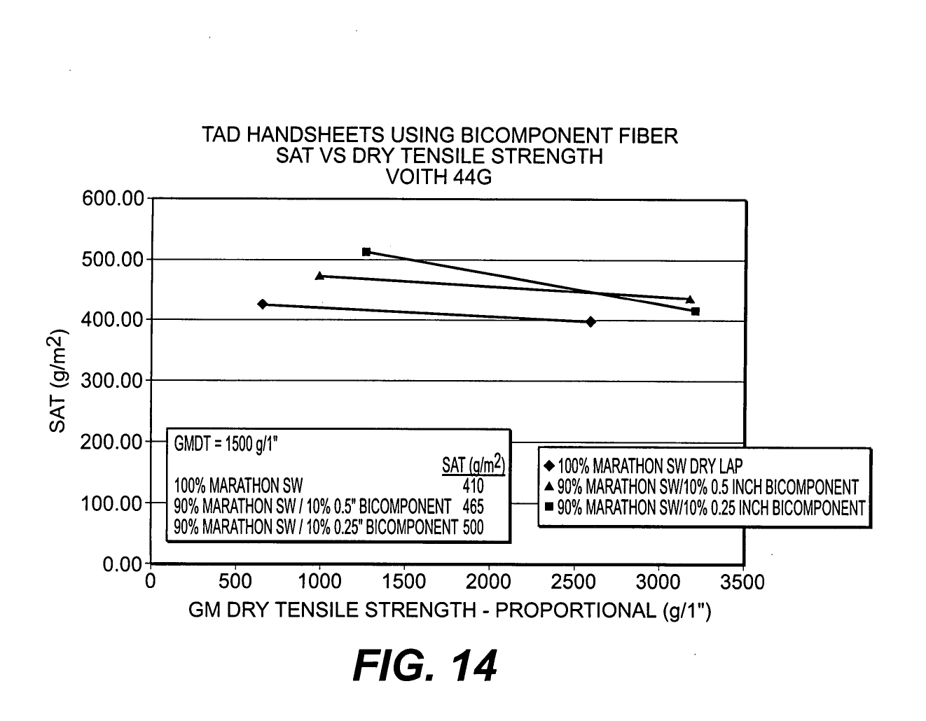

FIG. 13 shows the relationship between SAT and GM dry tensile strength for handsheets made and dried on a 100-mesh screen. FIG. 14 shows the relationship between SAT and GM dry tensile strength for handsheets dried and shaped using a Voith 44G TAD fabric. From FIG. 13, at 1500 GMT, SAT increased 13% for handsheets containing 0.50-inch bicomponent fiber and 24% for handsheets containing 0.25-inch bicomponent fiber versus a control without bicomponent fiber. FIG. 14 shows the improvements with the addition of bicomponent fiber are approximately the same when drying and shaping handsheets using a Voith 44G TAD fabric.

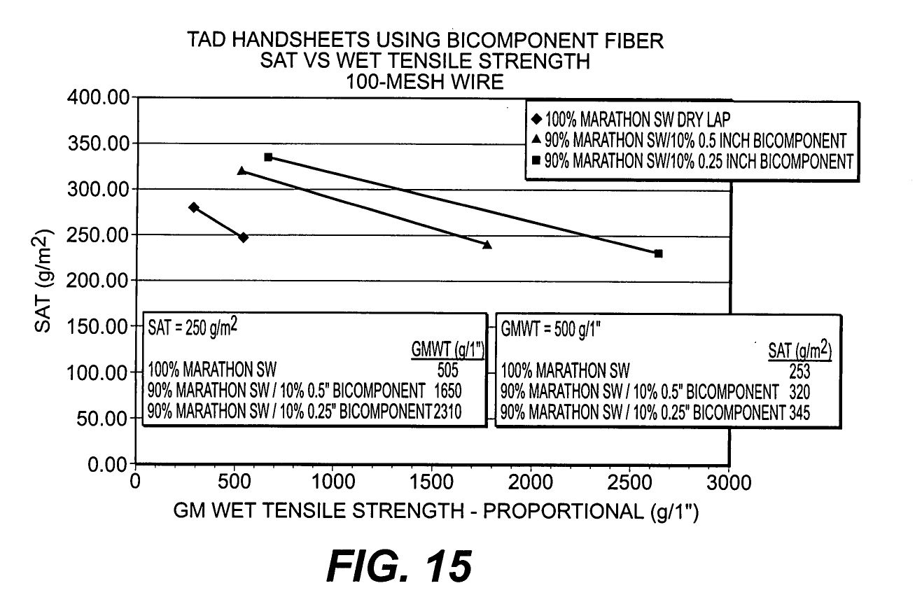

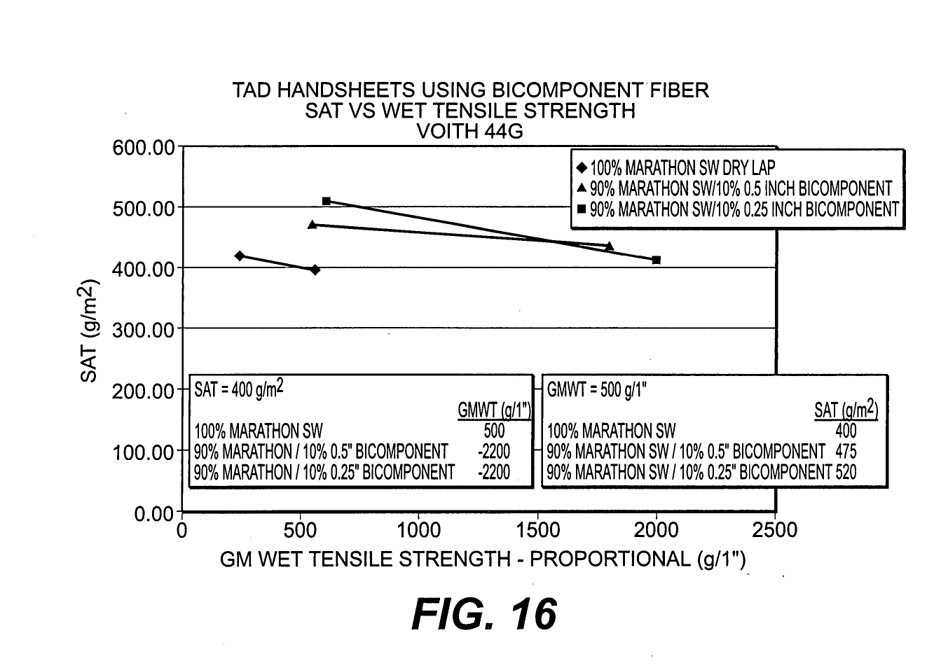

FIG. 15 shows the relationship between SAT and GM wet tensile strength for handsheets dried on a 100-mesh screen. FIG. 16 shows the relationship between SAT and GM wet tensile strength for handsheets dried on a Voith 44G TAD fabric. From FIG. 15, at about 500 GMWT, SAT increased about 31% for handsheets made with 0.50-inch and 0.25-inch bicomponent fiber over a control containing 0% bicomponent fiber. FIG. 16 shows the improvements with the addition of bicomponent fiber are approximately the same when drying and shaping handsheets using the Voith 44G TAD fabric.

There are substantial strength increases when using bicomponent fiber technology. For example, from FIG. 15, at 250 g/m² SAT, bicomponent fiber yields a substantial increase in GM wet tensile strength (greater than 200%). FIG. 16 shows the improvements in GM wet tensile strength with the addition of bicomponent fiber are approximately the same for handsheets dried and formed on the Voith 44G TAD fabric.

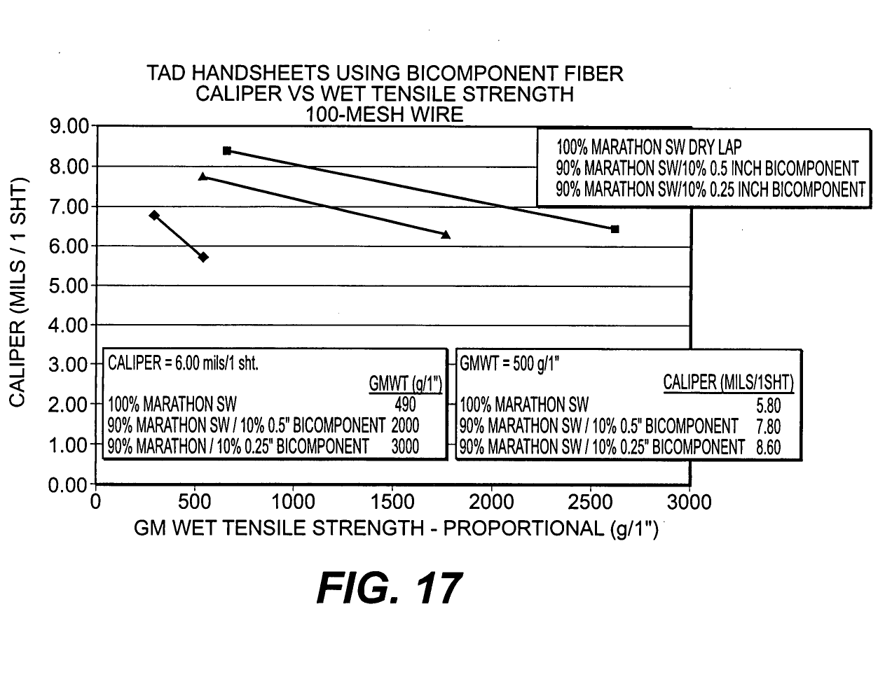

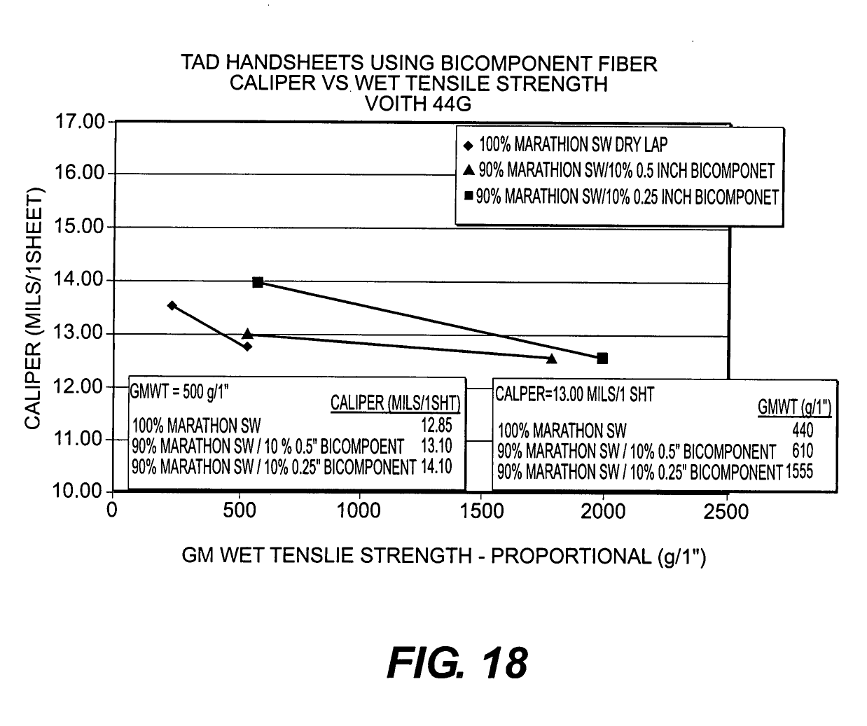

FIG. 17 shows the relationship between caliper and GM wet tensile strength for handsheets dried on a 100-mesh screen. FIG. 18 shows the relationship between caliper and GM wet tensile strength for handsheets dried and shaped on the Voith 44G TAD fabric. From FIG. 17, at 500 GMWT, Caliper increased 35% for handsheets made from 0.50-inch bicomponent fiber and 48% for handsheets made from 0.25-inch bicomponent fiber versus a control devoid of bicomponent fiber. FIG. 18 shows that improvements in caliper are obtained, when adding bicomponent fiber to handsheets dried and shaped using the Voith 44G TAD fabric.

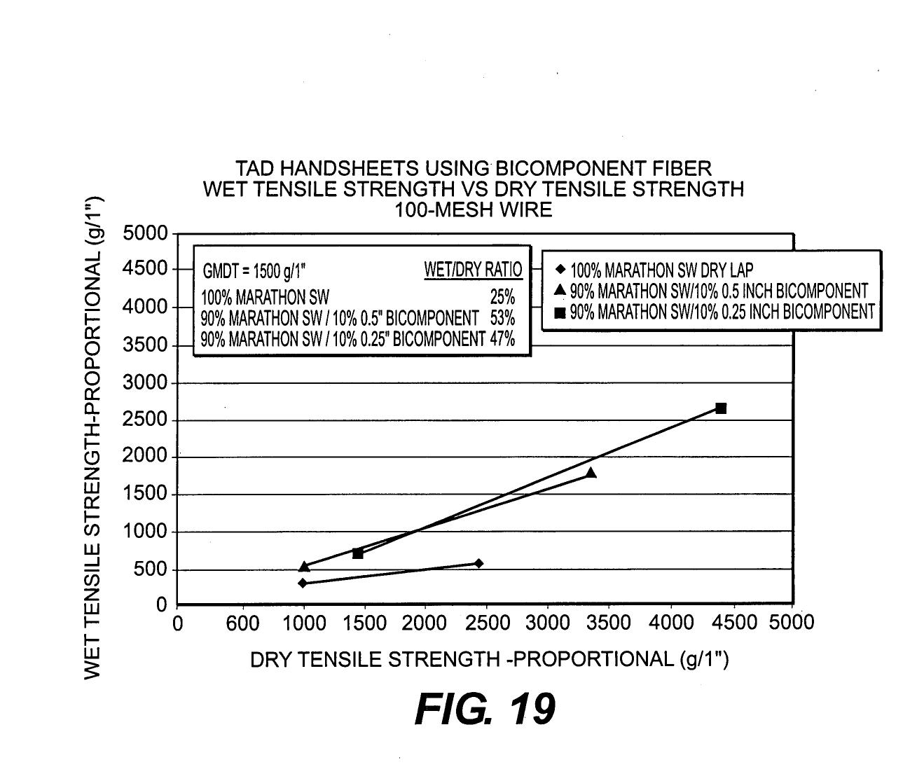

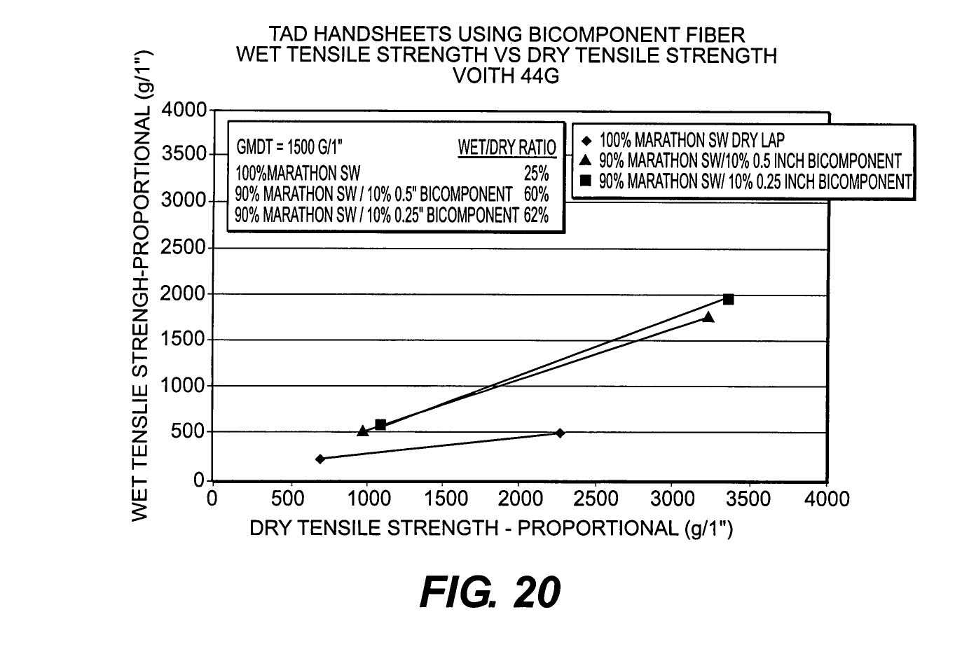

FIG. 19 shows the relationship between GM wet tensile strength and GM dry tensile strength for handsheets dried on a 100-mesh wire. FIG. 20 shows the relationship between GM wet tensile strength and GM dry tensile strength for handsheets dried and shaped using a Voith 44G TAD fabric. At 1500 GM dry tensile strength, FIGS. 19 and 20 show wet/dry tensile strength ratio data for handsheets containing bicomponent fiber that is more than double the wet/dry tensile strength ratio of control handsheets devoid of bicomponent fiber. As a result, the addition of bicomponent fiber to handsheets allows wet tensile strength targets to be achieved at lower dry tensile strength levels, consequently driving handfeel to higher levels.

### Examples 32-44

Examples 32-35, 37, 41: Control—100% pulp

Example 36: 1% Celbond, 85% pulp

Examples 38-40:15% 2.9 denier PLA/PET, 85% pulp

Examples 42-44:15% 3.4 denier PLA/PP, 85% pulp

All synthetic fibers were 6 mm in length.

Examples 32-35: A 15 lb/ream control was made with 50% Naheola SW refined to 500 CSF and 50% Naheola HW. The product was creped using a PVOH based creping adhesive in an amount of 1.5 lbs/ton and a 15° bevel blade at a 86° creping angle. The results were poor and thus, the control was repeated with the same creping adhesive mixture at 0.75 lbs/ton. The same result occurred. Wet strength agents were added to the control in an amount of 16 lbs/ton. The wet strength agent was added to the softwood pulp before the fan pump. This amount of wet strength agent caused foaming of the furnish. Another control sample was produced and the creping adhesive was modified slightly to increase the amount of PVOH. The adhesive was again applied in an amount of 1.5 lbs/ton. The sheet was creped at a 15° bevel blade. The sheet was dried on a Yankee at a temperature of about 242° F. The tension between the Yankee and reel was measured at 1.6 tensiometer.

Example 36: This sample was made in the same manner as Examples 32-35. Celbond bicomponent fiber was added directly to the hardwood (HW) tank and the tensiometer went to zero when the fiber reached the dryer. The sample was creped using a 8° bevel blade at a 79° creping angle. Creping of this sample was improved. The tension between the Yankee and reel was measured at 0.5-0.6 tensiometer. The creped product could be characterized as coarse and non-uniform, but acceptable for making rolls to access physical properties.

Example 37: A 100% pulp control was made using an 8° bevel creping blade to compare against the Celbond cell with 8° bevel blade.

Example 38: 2.9 denier PLA/PET fiber was added to the hardwood (HW) tank such that 30% of the fiber in the tank was synthetic. The 50/50 split from each tank resulted in a furnish of 50% Naheola SW, 35% Naheola HW, and 15% synthetic. Agitator speed was increased in the HW tank, but no water was added to compensate for the fiber. The synthetic fiber dispersed well and formed well. The foam caused primarily by the wet strength resin seemed slightly worse after the synthetic fiber was added. Not wishing to be bound by theory, the increase in foam product may perhaps be due to the finish applied to the synthetic fiber during fiber processing. Sheet formation appeared floccier, and this may be at least partially attributed to less short fiber to fill in the sheet. When the fiber hit the dryer, the sheet disintegrated on the 8° bevel blade.

Example 39: This example was carried out just as Example 38, except that another creping angle was used. A 15° bevel creping blade was tried unsuccessfully. The behavior was consistent with the PLA “melting” even though the dryer temperature was well below 130° C.

Example 40: Another sample with PLA fiber was produced as described in Example 38, however, the dryer temperature was brought down to 208° F., the coating was removed from the spray header and water only was used, and a 20° bevel creping blade at a 91° creping angle was installed. These actions resulted in good creping. The sheet was wet, and the dryer temperature was gradually increased to 242° F. Sheet tensile increased with the dryer temperature, suggesting increasing thermal bonding on the dryer. The creping was very fine and not well defined. The Yankee side appeared smooth.

Example 41: A control was made with 100% pulp and a 200 bevel creping blade to compare against the 2.9 denier PLA/PET cell.

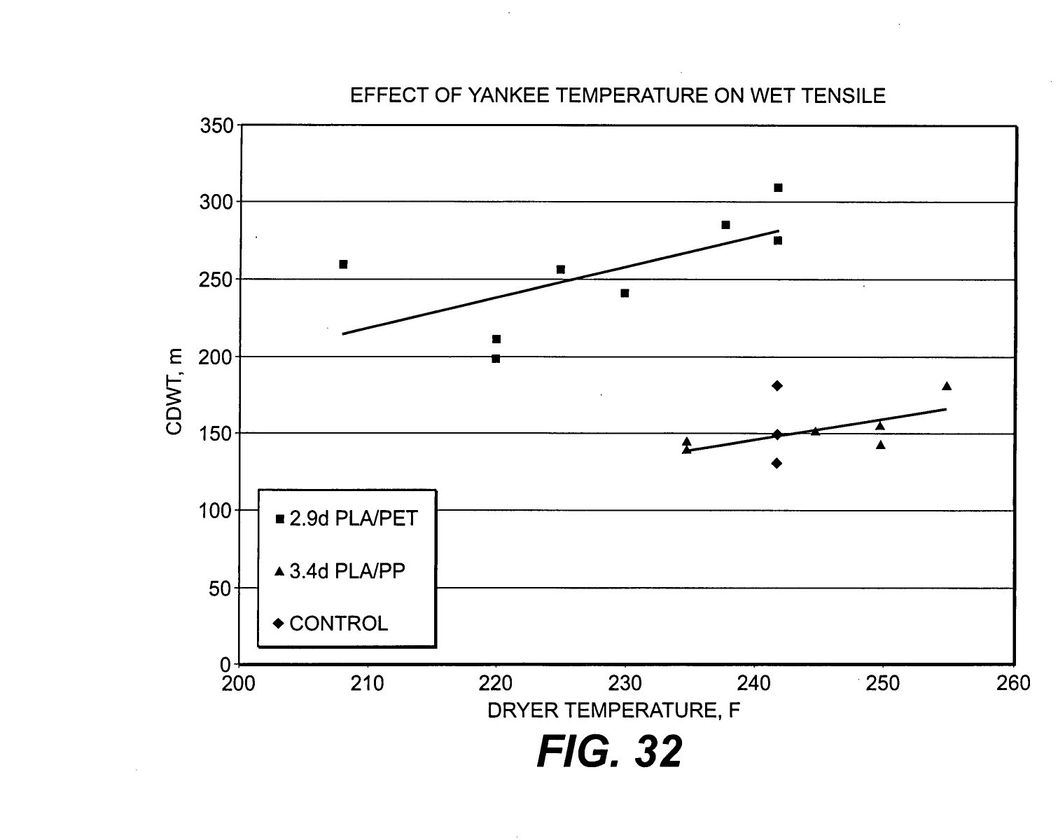

Examples 42-44: 3.4 denier PLA/PP synthetic fiber was added to the HW tank like previous synthetic fiber cells. A 20° bevel creping blade ran well, but with less tension on the tensiometer than the 100% pulp cell. 15° and 8° bevel creping blades also ran well. A 15° bevel creping blade was used for the remainder of the synthetic cell, and coating remained on at the same level as the 100% pulp cell. Dryer temperature was gradually increased from 235° F. to 255° F. to attempt to thermally bond on the dryer. There was a slight increase in CDWT when the dryer reached 255° F. The results of the effect of Yankee temperature increases CD wet tensile are set forth in FIG. 32.

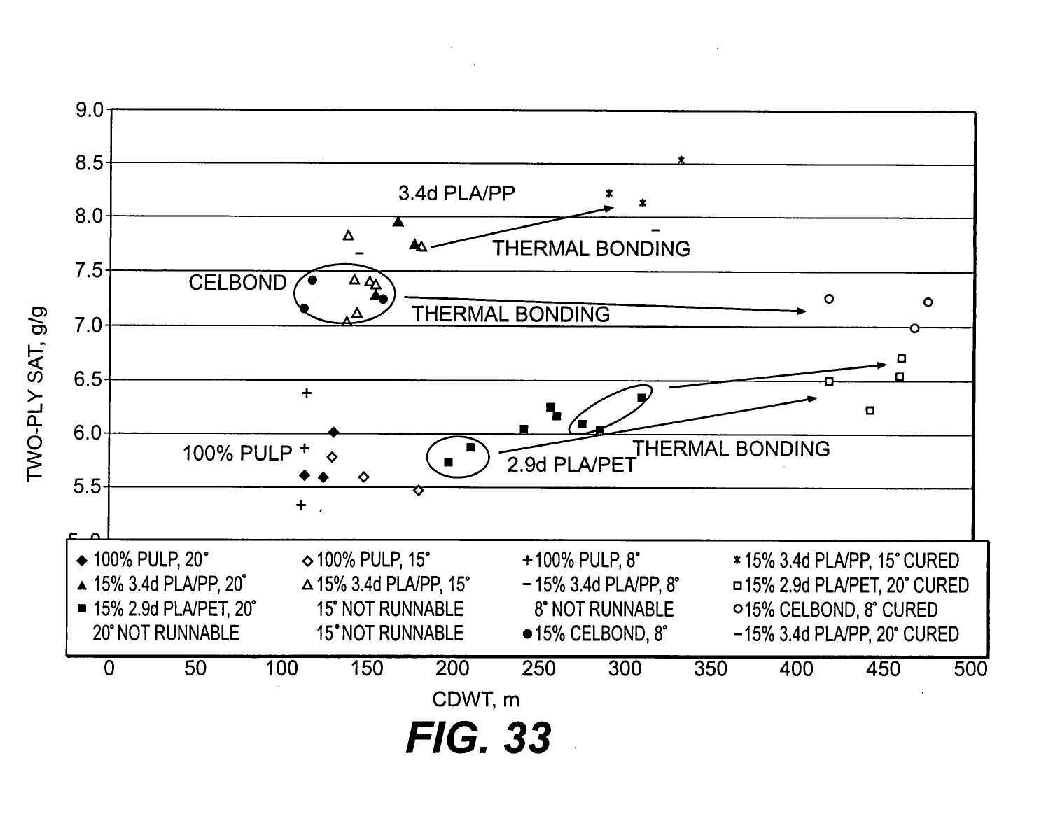

FIG. 33 summarizes the results of the Examples 32-44, including fiber type, crepe blade and thermal bonding. Synthetic fiber at 15% of furnish caused SAT to increase 15-40+% higher than sheets with 100% pulp. As seen in FIG. 33, synthetic fiber shifts the SAT/CDWT curve higher. FIG. 33 shows that thermal bonding helps SAT in a base sheet made with PLA fiber. All samples noted as “cured” were thermally bonded in an oven at 154° C. for five minutes. Solid symbols represent base sheet as it came off the papermaking machine. The hollow symbols of similar shape represent the base sheet after heat treatment. As can be seen in FIG. 33, Celbond is neutral. SAT rate is higher for 3.4 denier PLA/PP fiber than for Celbond. The SAT rate for a sheet made with PLA/PET fiber is about the same as Celbond.

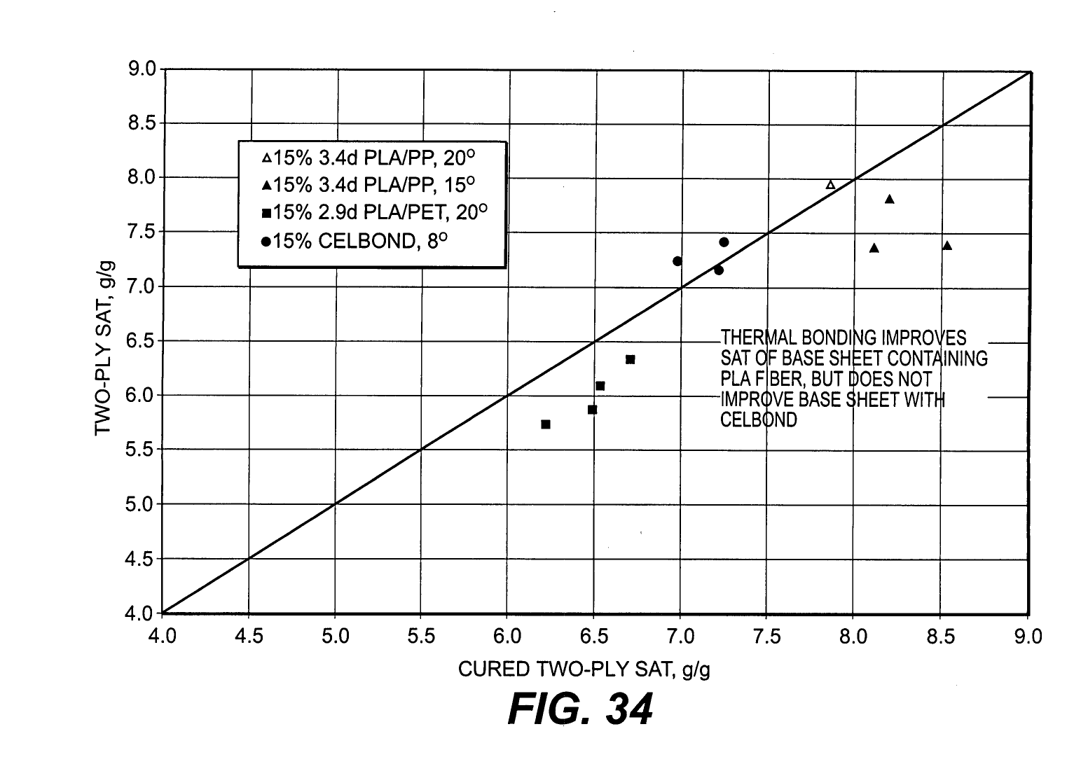

FIG. 34 shows the effect of thermal bonding on SAT in sheets made with PLA and Celbond.

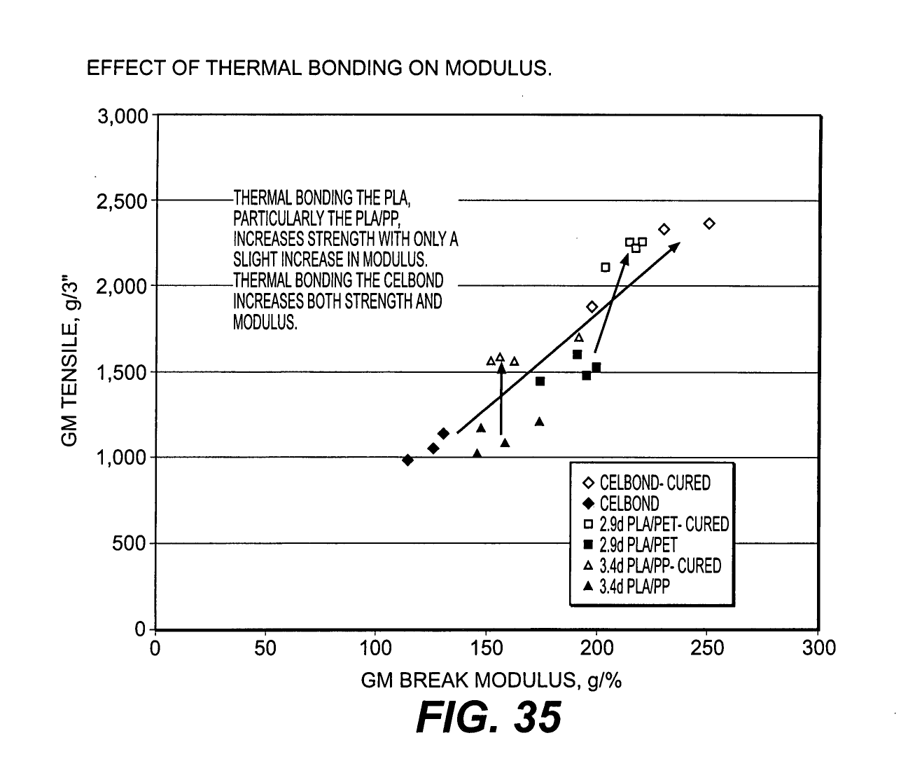

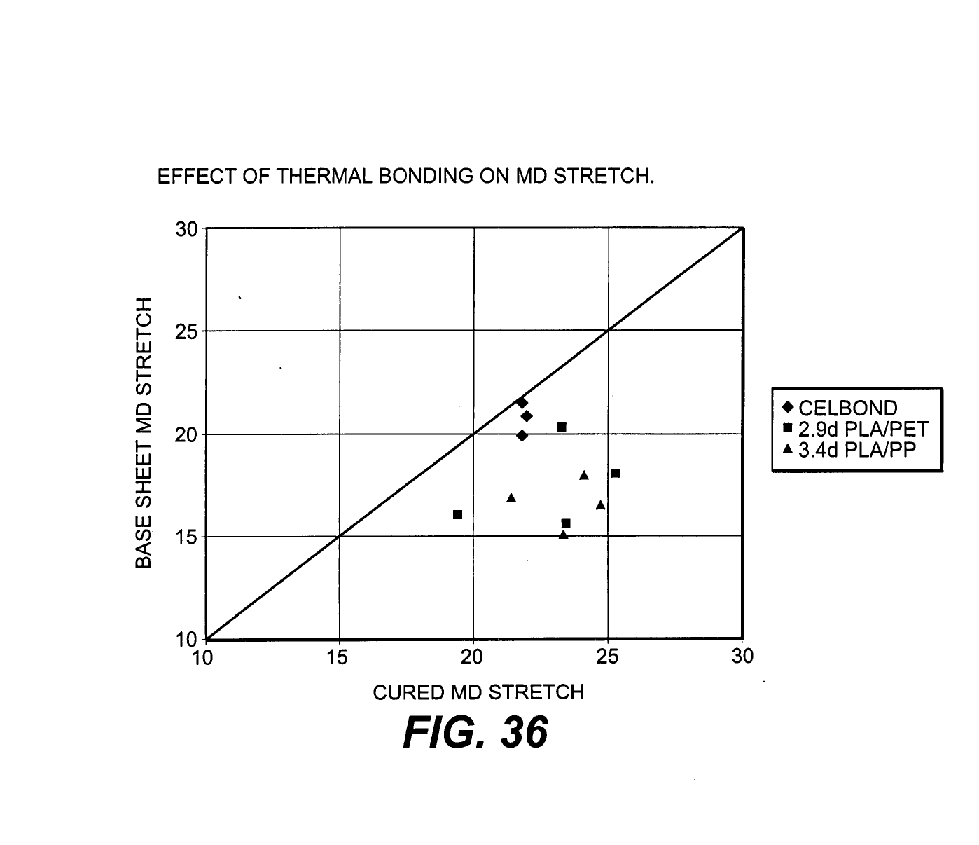

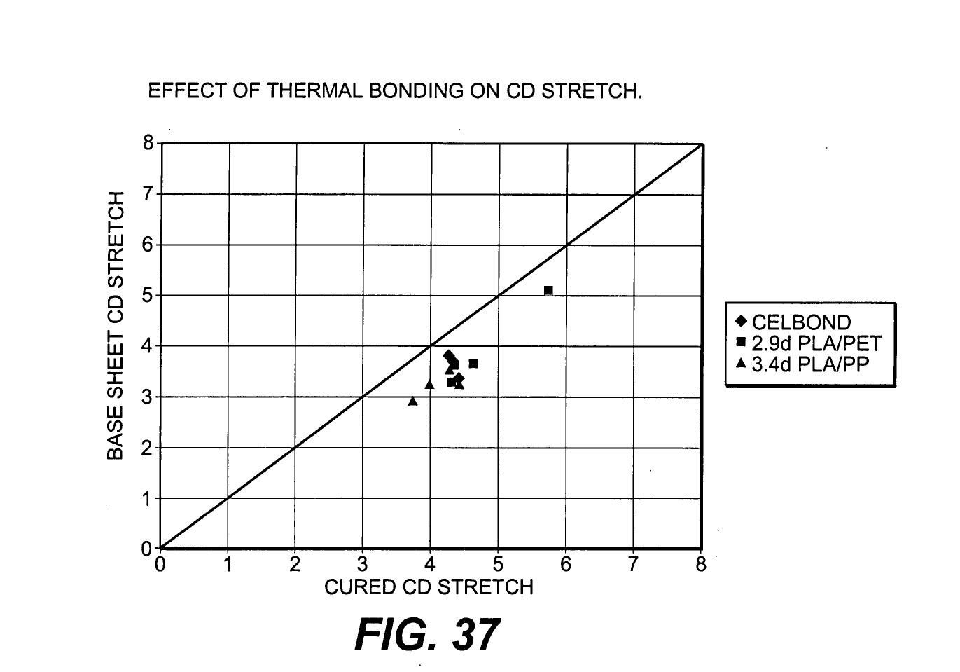

FIG. 35 shows the effect of thermal bonding on sheet modulus. Thermal bonding a sheet with Celbond makes the sheet stiffer (84% increased GM modulus). Thermal bonding a sheet with PLA fiber makes the sheet slightly stiffer (10% increased GM modulus). In the PLA sheet, the increased tensile from thermal bonding is compensated for by increased MD and CD stretch. (See FIGS. 36 and 37.)

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A paper product comprising:
papermaking fiber; and
a thermally bondable fiber exhibiting hydrophilicity, wherein said product has been wet formed.

2. The paper product according to claim 1, wherein the papermaking fiber is wood fiber.

3. The paper product according to claim 1, wherein the thermally bondable fiber is chosen from at least one of a bicomponent and a tricomponent fiber.

4. The paper product according to claim 1, wherein the thermally bondable fiber is a bicomponent fiber that comprises one or more polyesters, polyolefins, copolyolefins, polyethylenes, polypropylenes, polybutylenes, polyethylene terephthalates, poly trimethylene terephthalates, polybutylene terephthalates, polyurethanes, polyamides, polycarboxylic acids, alkylene oxides, polylactic acids, and mixtures thereof.

5. The paper product according to claim 1, wherein the thermally bondable fiber is a tricomponent fiber that comprises one or more polyesters, polyolefins, copolyolefins, polyethylenes, polypropylenes, polybutylenes, polyethylene terephthalates, poly trimethylene terephthalates, polybutylene terephthalates, polyurethanes, polyamides, polycarboxylic acids, alkylene oxides, polylactic acids, and mixtures thereof.

6. The paper product according to claim 1, wherein the thermally bondable fiber is surface modified by the introduction of a surfactant being chosen from at least one of an anionic, a cationic, a zwitterionic, and a non-ionic surfactant.

7. The paper product according to claim 6, wherein the surfactant comprises a non-ionic surfactant.

8. The paper product according to claim 1, further comprising a wet-strength resin.

9. The paper product according to claim 8, wherein the wet-strength resin is chosen from at least one of permanent wet strength agents and temporary wet strength agents.

10. The paper product according to claim 9, wherein the wet strength resin comprises a permanent wet strength agent chosen from at least one of aliphatic and aromatic aldehydes, urea-formaldehyde resins, melamine formaldehyde resins, and polyamide-epichlorohydrin resins.

11. The paper product according to claim 9, wherein the wet-strength resin comprises a temporary wet strength agent chosen from at least one of aliphatic and aromatic aldehydes, glyoxal, malonic dialdehyde, succinic dialdehyde, glutaraldehyde, dialdehyde starches, substituted or reacted starches, disaccharides, polysaccharides, polyethylene imine, chitosan, and reacted polymeric reaction products of monomers or polymers having aldehyde groups.

12. The paper product according to claim 1, further comprising a dry strength agent chosen from at least one of starch, guar gum, polyacrylamides, and carboxymethyl cellulose.

13. The paper product according to claim 1, wherein the thermally bondable fiber is present in an amount of not less than about 2%.

14. The paper product according to claim 1, wherein the thermally bondable fiber is present in an amount of not more than about 50%.

15. The paper product according to claim 1, wherein the thermally bondable fiber is present in an amount of from about 5 to about 30%.

16. The paper product according to claim 1, wherein the product is a stratified product.

17. The paper product according to claim 1, wherein the product is a homogeneous product.

18. The paper product according to claim 1, wherein the thermally bondable fiber has a length of not less than about 1 mm.

19. The paper product according to claim 1, wherein the thermally bondable fiber has a length of not more than about 25 mm.

20. The paper product according to claim 1, wherein the thermally bondable fiber has a length of from about 6 to about 13 mm.

21. The paper product according to claim 1 having a basis weight of not less than about 10 lbs/ream.

22. The paper product according to claim 1 having a basis weight of not more than about 60 lbs/ream.

23. The paper product according to claim 1 having a basis weight of from about 13 to about 40 lbs/ream.

24. The paper product according to claim 1, wherein the fibers a bonded by heat treatment.

25. The paper product according to claim 1, wherein the product is embossed.

26. The paper product according to claim 25, wherein the fibers are bonded by heat treatment.

27. The paper product according to claim 26, wherein the fibers are thermally bonded before or after the embossing.

28. A paper product comprising:
papermaking fiber; and
a thermally bondable fiber exhibiting hydrophilicity;
wherein the paper product has been wet formed; and
wherein the paper product exhibits of Wet Breaking Length of at least about 250 meters.

29. The paper product according to claim 28, wherein the Wet Breaking Length is at least about 300 meters.

30. The paper product according to claim 28 wherein the Wet Breaking Length is from about 250 meters to about 500 meters.

31. The paper product according to claim 28, wherein the papermaking fiber is wood fiber.

32. The paper product according to claim 28, wherein the thermally bondable fiber is chosen from at least one of a bicomponent and a tricomponent fiber.

33. The paper product according to claim 32, wherein the thermally bondable fiber is a bicomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

34. The paper product according to claim 32, wherein the thermally bondable fiber is a tricomponent fiber that comprises one or more polyesters, polyolefins, copolyolefins, polyethylenes, polypropylenes, polybutylenes, polyethylene terephthalates, polytrimethylene terephthalate, polybutylene terephthalates, polyurethanes, polyamides, polycarboxylic acids, alkylene oxides, polylactic acids, and mixtures thereof.

35. The paper product according to claim 28, wherein the thermally bondable fiber is surface modified by the introduction of a surfactant being chosen from at least one of an anionic, a zwitterionic, a cationic, and a non-ionic surfactant.

36. The paper product according to claim 35, wherein the surfactant comprises a non-ionic surfactant.

37. The paper product according to claim 28, further comprising a wet-strength resin.

38. The paper product according to claim 37, wherein the wet-strength resin is chosen from at least one of permanent wet strength agents and temporary wet strength agents.

39. The paper product according to claim 38, wherein the wet strength resin comprises a permanent wet strength agent chosen from at least one of aliphatic and aromatic aldehydes, urea-formaldehyde resins, melamine formaldehyde resins, and polyamide-epichlorohydrin resins.

40. The paper product according to claim 38, wherein the wet-strength resin comprises a temporary wet strength agent chosen from at least one of aliphatic and aromatic aldehydes, glyoxal, malonic dialdehyde, succinic dialdehyde, glutaraldehyde, dialdehyde starches, substituted or reacted starches, disaccharides, polysaccharides, polyethylene imine, chitosan, and reacted polymeric reaction products of monomers or polymers having aldehyde groups.

41. The paper product according to claim 28, further comprising a dry strength agent chosen from at least one of starch, guar gum, polyacrylamides, and carboxymethyl cellulose.

42. The paper product according to claim 28, wherein the thermally bondable fiber is present in an amount of not less than about 2%.

43. The paper product according to claim 28, wherein the thermally bondable fiber is present in an amount of not more than about 50%.

44. The paper product according to claim 28, wherein the thermally bondable fiber is present in an amount of from about 5 to about 30%.

45. The paper product according to claim 28, wherein the product is a stratified product.

46. The paper product according to claim 28, wherein the product is a homogeneous product.

47. The paper product according to claim 28, wherein the thermally bondable fiber has a length of not less than about 1 mm.

48. The paper product according to claim 28, wherein the thermally bondable fiber has a length of not more than about 25 mm.

49. The paper product according to claim 28, wherein the thermally bondable fiber has a length of from about 6 to about 13 mm.

50. The paper product according to claim 28, having a basis weight of not less than about 10 lbs/ream.

51. The paper product according to claim 28, having a basis weight of not more than about 60 lbs/ream.

52. The paper product according to claim 28, having a basis weight of from about 13 to about 40 lbs/ream.

53. The paper product according to claim 28, wherein the fibers are bonded by heat treatment.

54. The paper product according to claim 28, wherein the product is embossed.

55. The paper product according to claim 54, wherein the fibers are bonded by heat treatment.

56. The paper product according to claim 55, wherein the fibers are thermally bonded before or after the embossing.

57. A paper product comprising:
papermaking fiber; and
a thermally bondable fiber exhibiting hydrophilicity;
wherein the paper product has been wet formed; and
wherein the paper product exhibits a CD Wet Breaking Length of at least about 250 meters and a SAT of at least about 5 g/g.

58. The paper product according to claim 57, wherein the CD Wet Breaking Length is at least about 300 meters.

59. The paper product according to claim 57, wherein the CD Wet Breaking Length is from about 250 meters to about 500 meters

60. The paper product according to claim 57, wherein the SAT is at least about 6 g/g.

61. The paper product according to claim 57, wherein the SAT is from about 5 g/g to about 14 g/g.

62. The paper product according to claim 57, wherein the papermaking fiber is wood fiber.

63. The paper product according to claim 57, wherein the thermally bondable fiber is chosen from at least one of a bicomponent and a tricomponent fiber.

64. The paper product according to claim 63, wherein the thermally bondable fiber is a bicomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

65. The paper product according to claim 63, wherein the thermally bondable fiber is a tricomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

66. The paper product according to claim 57, wherein the thermally bondable fiber is surface modified the introduction of a surfactant being chosen from at least one of an anionic, a zwitterionic, cationic, and a non-ionic surfactant.

67. The paper product according to claim 66, wherein the surfactant comprises a non-ionic surfactant.

68. The paper product according to claim 57, further comprising a wet-strength resin.

69. The paper product according to claim 68, wherein the wet-strength resin is chosen from at least one of permanent wet strength agents and temporary wet strength agents.

70. The paper product according to claim 69, wherein the wet strength resin comprises a permanent wet strength agent chosen from at least one of aliphatic and aromatic aldehydes, urea-formaldehyde resins, melamine formaldehyde resins, and polyamide-epichlorohydrin resins.

71. The paper product according to claim 69, wherein the wet-strength resin comprises a temporary wet strength agent chosen from at least one of aliphatic and aromatic aldehydes, glyoxal, malonic dialdehyde, succinic dialdehyde, glutaraldehyde, dialdehyde starches, substituted or reacted starches, disaccharides, polysaccharides, polyethylene imine, chitosan, and reacted polymeric reaction products of monomers or polymers having aldehyde groups.

72. The paper product according to claim 57, further comprising a dry strength agent chosen from at least one of starch, guar gum, polyacrylamides, and carboxymethyl cellulose.

73. The paper product according to claim 57, wherein the thermally bondable fiber is present in an amount of not less than about 2%.

74. The paper product according to claim 57, wherein the thermally bondable fiber is present in an amount of not more than about 50%.

75. The paper product according to claim 57, wherein the thermally bondable fiber is present in an amount of from about 5 to about 30%.

76. The paper product according to claim 57, wherein the product is a stratified product.

77. The paper product according to claim 57, wherein the product is a homogeneous product.

78. The paper product according to claim 57, wherein the thermally bondable fiber has a length of not less than about 1 mm.

79. The paper product according to claim 57, wherein the thermally bondable fiber has a length of not more than about 25 mm.

80. The paper product according to claim 57, wherein the thermally bondable fiber has a length of from about 6 to about 13 mm.

81. The paper product according to claim 57, having a basis weight of not less than about 10 lbs/ream.

82. The paper product according to claim 57, having a basis weight of not more than about 60 lbs/ream.

83. The paper product according to claim 57, having a basis weight of from about 13 to about 40 lbs/ream.

84. The paper product according to claim 57, wherein the fibers are bonded by heat treatment.

85. The paper product according to claim 57, wherein the product is embossed.

86. The paper product according to claim 85, wherein the fibers are bonded by heat treatment.

87. The paper product according to claim 86, wherein the fibers are thermally bonded after the embossing.

88. A paper product comprising:
papermaking fiber; and
a thermally bondable fiber exhibiting hydrophilicity;
wherein said product has been wet formed; and
wherein the paper product exhibits a reticulated matrix of thermally bondable fibers.

89. The paper product according to claim 88, wherein the CD Wet Breaking Length is at least about 250 meters.

90. The paper product according to claim 88, wherein the CD Wet Breaking Length is from about 250 meters to about 500 meters

91. The paper product according to claim 88, wherein the SAT is at least about 5 g/g.

92. The paper product according to claim 88, wherein the SAT is from about g/g to about 14 g/g.

93. The paper product according to claim 88, wherein the papermaking fiber is wood fiber.

94. The paper product according to claim 88, wherein the thermally bondable fiber is chosen from at least one of a bicomponent and a tricomponent fiber.

95. The paper product according to claim 94, wherein the thermally bondable fiber is a bicomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

96. The paper product according to claim 94, wherein the thermally bondable fiber is a tricomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

97. The paper product according to claim 88, wherein the thermally bondable fiber is surface modified by the introduction of a surfactant being chosen from at least one of an anionic, a zwitterionic, a cationic, and a non-ionic surfactant.

98. The paper product according to claim 97, wherein the surfactant comprises a non-ionic surfactant.

99. The paper product according to claim 88, further comprising a wet-strength resin.

100. The paper product according to claim 99, wherein the wet-strength resin is chosen from at least one of permanent wet strength agents and temporary wet strength agents.

101. The paper product according to claim 100, wherein the wet strength resin comprises a permanent wet strength agent chosen from at least one of aliphatic and aromatic aldehydes, urea-formaldehyde resins, melamine formaldehyde resins, and polyamide-epichlorohydrin resins.

102. The paper product according to claim 100, wherein the wet-strength resin comprises a temporary wet strength agent chosen from at least one of aliphatic and aromatic aldehydes, glyoxal, malonic dialdehyde, succinic dialdehyde, glutaraldehyde, dialdehyde starches, substituted or reacted starches, disaccharides, polysaccharides, polyethylene imine, chitosan, and reacted polymeric reaction products of monomers or polymers having aldehyde groups.

103. The paper product according to claim 88, further comprising a dry strength agent chosen from at least one of starch, guar gum, polyacrylamides, and carboxymethyl cellulose.

104. The paper product according to claim 88, wherein the thermally bondable fiber is present in an amount of not less than about 2%.

105. The paper product according to claim 88, wherein the thermally bondable fiber is present in an amount of not more than about 50%.

106. The paper product according to claim 88, wherein the thermally bondable fiber is present in an amount of from about 5 to about 30%.

107. The paper product according to claim 88, wherein the product is a stratified product.

108. The paper product according to claim 88, wherein the product is a homogeneous product.

109. The paper product according to claim 88, wherein the thermally bondable fiber has a length of not less than about 1 mm.

110. The paper product according to claim 88, wherein the thermally bondable fiber has a length of not more than about 25 mm.

111. The paper product according to claim 88, wherein the thermally bondable fiber has a length of from about 6 to about 13 mm.

112. The paper product according to claim 88, having a basis weight of not less than about 10 lbs/ream.

113. The paper product according to claim 88, having a basis weight of not more than about 60 lbs/ream.

114. The paper product according to claim 88, having a basis weight of from about 13 to about 40 lbs/ream.

115. The paper product according to claim 88, wherein the fibers are bonded by heat treatment.

116. The paper product according to claim 88, wherein the product is embossed.

117. The paper product according to claim 116, wherein the fibers are bonded by heat treatment.

118. The paper product according to claim 117, wherein the fibers are thermally bonded before or after the embossing.

119. A method of making a paper product comprising:
dispersing papermaking fibers in an aqueous solution;
dispersing thermally bondable fibers exhibiting hydrophilicity in an aqueous solution;
forming said papermaking fibers and said thermally bondable fibers into a nascent web, wherein said web is formed at a line speed in excess of 1000 ft/min., and
drying said web.

120. The method according to claim 119, wherein said papermaking fibers and said thermally bondable fibers are dispersed simultaneously.

121. The method according to claim 119, wherein said papermaking fibers and said thermally bondable fibers are dispersed sequentially.

122. The method according to claim 119, wherein the dispersion of fibers further comprises a wet strength adjusting agent.

123. The method according to claim 122, wherein the wet-strength resin is chosen from at least one of permanent wet strength agents and temporary wet strength agents.

124. The method according to claim 123, wherein the wet strength resin comprises a permanent wet strength agent chosen from at least one of aliphatic and aromatic aldehydes, urea-formaldehyde resins, melamine formaldehyde resins, and polyamide-epichlorohydrin resins.

125. The method according to claim 123, wherein the wet-strength resin comprises a temporary wet strength agent chosen from at least one of aliphatic and aromatic aldehydes, glyoxal, malonic dialdehyde, succinic dialdehyde, glutaraldehyde, dialdehyde starches, substituted or reacted starches, disaccharides, polysaccharides, polyethylene imine, chitosan, and reacted polymeric reaction products of monomers or polymers having aldehyde groups.

126. The method according to claim 119, further comprising a dry strength agent chosen from at least one of starch, guar gum, polyacrylamides, and carboxymethyl cellulose.

127. The method according to claim 119, wherein said web is formed by conventional wet pressing.

128. The method according to claim 127, wherein said web is creped from a Yankee dryer.

129. The method according to claim 127, wherein the fibers in the web are stratified.

130. The method according to claim 119, wherein said web is formed by through air drying.

131. The method according to claim 130, wherein said web is creped from a Yankee dryer.

132. The method according to claim 130, wherein said web is uncreped.

133. The method according to claim 130, wherein the fibers in the web are stratified.

134. The method according to claim 119, wherein the dried paper web is subject to heat treatment.

135. The method according to claim 134, wherein the heat treatment is carried out at a temperature of at least about 165° F.

136. The method according to claim 134, wherein the heat treatment is carried out at a temperature of between about 200° F. and about 310° F.

137. The method according to claim 119, wherein the papermaking fiber is wood fiber.

138. The method according to claim 119, wherein the thermally bondable fiber is chosen from at least one of a bicomponent or a tricomponent fiber.

139. The method according to claim 138, wherein the thermally bondable fiber is a bicomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

140. The method according to claim 138, wherein the thermally bondable fiber is a tricomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

141. The method according to claim 119, wherein the thermally bondable fiber is surface is modified by the introduction of a surfactant chosen from at least one of an anionic, a zwitterionic, a cationic, and a non-ionic surfactant.

142. The method according to claim 141, wherein the surfactant comprises a non-ionic surfactant.

143. The method according to claim 119, wherein the thermally bondable fiber is present in an amount of not less than about 2%.

144. The method according to claim 119, wherein the thermally bondable fiber is present in an amount of not more than about 50%.

145. The method according to claim 119, wherein the thermally bondable fiber is present in an amount of from about 5 to about 30%.

146. The method according to claim 119, wherein the fibers in the web are homogeneous.

147. The method according to claim 119, wherein the thermally bondable fiber has a length of not less than about 1 mm.

148. The method according to claim 119, wherein the thermally bondable fiber has a length of not more than about 25 mm.

149. The method according to claim 119, wherein the thermally bondable fiber has a length of from about 6 to about 13 mm.

150. The method according to claim 119, further comprising embossing the web.

151. The method according to claim 150, wherein the dried paper web is subject to heat treatment.

152. The method according to claim 151, wherein the heat treatment is carried out at a temperature of at least about 165° F.

153. The method according to claim 152, wherein the heat treatment is carried out at a temperature of between about 200° F. and about 310° F.

154. A repulpable sheet paper product comprising:
papermaking fibers; and
thermally bondable fibers exhibiting hydrophilicity, wherein said thermally bondable fibers have not been subjected to heat treatment.

155. The repulpable sheet paper product according to claim 154, wherein the papermaking fiber is wood fiber.

156. The repulpable sheet paper product according to claim 154, wherein the thermally bondable fiber is chosen from at least one of a bicomponent or a tricomponent fiber.

157. The repulpable sheet paper product according to claim 156, wherein the thermally bondable fiber is a bicomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

158. The repulpable sheet paper product according to claim 156, wherein the thermally bondable fiber is a tricomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

159. The repulpable sheet paper product according to claim 154, wherein the thermally bondable fiber is modified by the introduction of a surfactant chosen from at least one of an anionic, a zwitterionic, a cationic and a non-ionic surfactant.

160. The repulpable sheet paper product according to claim 159, wherein the surfactant comprises a non-ionic surfactant.

161. The repulpable sheet paper product according to claim 154, wherein the thermally bondable fiber is present in an amount of not less than about 2%.

162. The repulpable sheet paper product according to claim 154, wherein the thermally bondable fiber is present in an amount of not more than about 50%.

163. The repulpable sheet paper product according to claim 154, wherein the thermally bondable fiber is present in an amount of from about 10 to about 30%.

164. The repulpable sheet paper product according to claim 154, wherein the fibers in the web are homogeneous.

165. The repulpable sheet paper product according to claim 154, wherein the thermally bondable fiber has a length of not less than about 1 mm.

166. The repulpable sheet paper product according to claim 154, wherein the thermally bondable fiber has a length of not more than about 25 mm.

167. The repulpable sheet paper product according to claim 154, wherein the thermally bondable fiber has a length of from about 6 to about 13 mm.

168. A method of making an embossed paper product comprising:
dispersing papermaking fibers in an aqueous solution;
dispersing thermally bondable fibers exhibiting hydrophilicity in an aqueous solution, wherein the thermally bondable fiber is chosen from at least one of a bicomponent or a tricomponent fiber;
forming said papermaking fibers and said thermally bondable fibers into a nascent web;
drying said web;
embossing said web; and
heat treating said web at a temperature of at least about 200° F.

169. The method according to claim 168, wherein said papermaking fibers and said thermally bondable fibers are dispersed simultaneously.

170. The method according to claim 168, wherein said papermaking fibers and said thermally bondable fibers are dispersed sequentially.

171. The method according to claim 168, wherein the dispersion of fibers further comprises a wet strength adjusting agent.

172. The method according to claim 171, wherein the wet-strength resin is chosen from at least one of permanent wet strength agents and temporary wet strength agents.

173. The method according to claim 172, wherein the wet strength resin comprises a permanent wet strength agent chosen from at least one of aliphatic and aromatic aldehydes, urea-formaldehyde resins, melamine formaldehyde resins, and polyamide-epichlorohydrin resins.

174. The method according to claim 172, wherein the wet-strength resin comprises a temporary wet strength agent chosen from at least one of aliphatic and aromatic aldehydes, glyoxal, malonic dialdehyde, succinic dialdehyde, glutaraldehyde, dialdehyde starches, substituted or reacted starches, disaccharides, polysaccharides, polyethylene imine, chitosan, and reacted polymeric reaction products of monomers or polymers having aldehyde groups.

175. The method according to claim 168, further comprising a dry strength agent chosen from at least one of starch, guar gum, polyacrylamides, and carboxymethyl cellulose.

176. The method according to claim 168, wherein said web is formed by conventional wet pressing.

177. The method according to claim 176, wherein said web is creped from a Yankee dryer.

178. The method according to claim 176, wherein the fibers in the web are stratified.

179. The method according to claim 168, wherein said web is formed by through air drying.

180. The method according to claim 179, wherein said web is creped from a Yankee dryer.

181. The method according to claim 179, wherein said web is uncreped.

182. The method according to claim 179, wherein the fibers in the web are stratified.

183. The method according to claim 168, wherein the papermaking fiber is wood fiber.

184. The method according to claim 168, wherein the thermally bondable fiber is a bicomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

185. The method according to claim 168, wherein the thermally bondable fiber is a tricomponent fiber that comprises one or more polyesters, polyolefins, copolyolefins, polyethylenes, polypropylenes, polybutylenes, polyethylene terephthalates, polytrimethylene terephthalates, polybutylene terephthalates, polyurethanes, polyamides, polycarboxylic acids, alkylene oxides, polylactic acids, and mixtures thereof.

186. The method according to claim 168, wherein the thermally bondable fiber is surface modified by the introduction of a surfactant chosen from at least one of an anionic, a zwitterionic, a cationic, and a non-ionic surfactant.

187. The method according to claim 186, wherein the surfactant comprises a non-ionic surfactant.

188. The method according to claim 168, wherein the thermally bondable fiber is present in an amount of not less than about 2%.

189. The method according to claim 168, wherein the thermally bondable fiber is present in an amount of not more than about 50%.

190. The method according to claim 168, wherein the thermally bondable fiber is present in an amount of from about 10 to about 30%.

191. The method according to claim 168, wherein the fibers in the web are homogeneous.

192. The method according to claim 168, wherein the thermally bondable fiber has a length of not less than about 1 mm.

193. The method according to claim 168, wherein the thermally bondable fiber has a length of not more than about 25 mm.

194. The method according to claim 168, wherein the thermally bondable fiber has a length of from about 6 to about 13 mm.

195. A papermaking apparatus comprising:
at least one fiber storage chest tank for housing an aqueous fiber slurry including thermally bondable fibers exhibiting hydrophilicity;
a slotted screen for screening said fiber to remove any large interfering matter before the fiber reaches the headbox;
a headbox for depositing the fiber onto a forming wire;
a forming wire for receiving the deposited fiber;
a drying structure including a press felt; and
a Yankee dryer.

196. The papermaking apparatus according to claim 195, further comprising
a fan pump.

197. The papermaking apparatus according to claim 195, further comprising a pulper.

198. The papermaking apparatus according to claim 195, further comprising an addition site for thermally bondable fiber, before said slotted screen.

199. The papermaking apparatus according to claim 196, further comprising an addition site for thermally bondable fiber, before said fan pump.

200. The papermaking apparatus according to claim 197, further comprising an addition site for thermally bondable fiber in the pulper.

201. A papermaking apparatus comprising:
at least one fiber storage chest tank for housing an aqueous fiber slurry including thermally bondable fibers exhibiting hydrophilicity;
a slotted screen for screening said fiber to remove any large interfering matter before the fiber reaches the headbox;
a headbox for depositing the fiber onto a forming wire;
a forming wire for receiving the deposited fiber; and
a through-air-dryer.

202. The papermaking apparatus according to claim 201, further comprising a Yankee dryer.

203. The papermaking apparatus according to claim 201, further comprising
a fan pump.

204. The papermaking apparatus according to claim 201, further comprising a pulper.

205. The papermaking apparatus according to claim 201, further comprising an addition site for thermally bondable fiber, before said slotted screen.

206. The papermaking apparatus according to claim 201, further comprising an addition site for thermally bondable fiber, before said fan pump.

207. The papermaking apparatus according to claim 202, further comprising an addition site for thermally bondable fiber in the pulper.

208. A paper product comprising:
papermaking fiber; and
a monocomponent thermally bondable fiber exhibiting hydrophilicity, and further exhibiting a softening profile extending through, and glass transition within, the temperature range used to dry the product;
wherein said product has been wet formed.

209. The paper product according to claim 208, wherein the papermaking fiber is wood fiber.

210. The paper product according to claim 208, wherein said monocomponent thermally bondable fiber is chosen from polylactic acids.

211. The paper product according to claim 208, wherein the monocomponent thermally bondable fiber is surface modified by the introduction of a surfactant being chosen from at least one of an anionic, a cationic, a zwitterionic, and a non-ionic surfactant.

212. The paper product according to claim 211, wherein the surfactant comprises a non-ionic surfactant.

213. The paper product according to claim 208, further comprising a wet-strength resin.

214. The paper product according to claim 213, wherein the wet-strength resin is chosen from at least one of permanent wet strength agents and temporary wet strength agents.

215. The paper product according to claim 214, wherein the wet strength resin comprises a permanent wet strength agent chosen from at least one of aliphatic and aromatic aldehydes, urea-formaldehyde resins, melamine formaldehyde resins, and polyamide-epichlorohydrin resins.

216. The paper product according to claim 214, wherein the wet-strength resin comprises a temporary wet strength agent chosen from at least one of aliphatic and aromatic aldehydes, glyoxal, malonic dialdehyde, succinic dialdehyde, glutaraldehyde, dialdehyde starches, substituted or reacted starches, disaccharides, polysaccharides, polyethylene imine, chitosan, and reacted polymeric reaction products of monomers or polymers having aldehyde groups.

217. The paper product according to claim 208, further comprising a dry strength agent chosen from at least one of starch, guar gum, polyacrylamides, and carboxymethyl cellulose.

218. The paper product according to claim 208, wherein the thermally bondable fiber is present in an amount of not less than about 2%.

219. The paper product according to claim 208, wherein the thermally bondable fiber is present in an amount of not more than about 50%.

220. The paper product according to claim 208, wherein the thermally bondable fiber is present in an amount of from about 5 to about 30%.

221. The paper product according to claim 208, wherein the product is a stratified product.

222. The paper product according to claim 208, wherein the product is a homogeneous product.

223. The paper product according to claim 208, wherein the thermally bondable fiber has a length of not less than about 1 mm.

224. The paper product according to claim 208, wherein the thermally bondable fiber has a length of not more than about 25 mm.

225. The paper product according to claim 208, wherein the thermally bondable fiber has a length of from about 6 to about 13 mm.

226. The paper product according to claim 208, having a basis weight of not less than about 10 lbs/ream.

227. The paper product according to claim 208, having a basis weight of not more than about 60 lbs/ream.

228. The paper product according to claim 208, having a basis weight of from about 13 to about 40 lbs/ream.

229. The paper product according to claim 208, wherein the fibers a bonded by heat treatment.

230. The method according to claim 168 wherein the web is heat treated at a temperature of at least about 260° F.
